(19) United States
(12) Patent Application Publication
(10) Pub. No.: US 2009/0076899 A1
(43) Pub. Date: Mar. 19, 2009

(54) METHOD FOR ANALYZING, SEARCHING FOR, AND TRADING TARGETED ADVERTISEMENT SPACES

(76) Inventor: Gbeminiyi A. Gbodimowo, San Jose, CA (US)

Correspondence Address: Walter J. Tencza Jr., Suite 210, 100 Menlo Park, Edison, NJ, 08837, US

(21) Appl. No.: 11/855,627

(22) Filed: Sep. 14, 2007

(51) Int. Cl. G06Q 30/00

(52) U.S. Cl. 705/14

(57) ABSTRACT

Methods, systems and apparatuses for creating and aggregating analytical data on advertisement spaces, searching for advertisement spaces that meet specific analytical criteria, and pricing and trading such advertisement spaces in an open and transparent way are described. Analytical information including tags, demographic distributions, geographic traffic statistics, ratings and reviews are compiled and categorized for each advertisement space. A user interface allows users to combine one or more queries to find advertisement spaces that meet their own needs. The user interface displays the results in thumbnail lists, tag clouds, tables or structured formats. Finally, when an advertisement space has been chosen, the trading system creates a stock market metaphor for buying and selling “Rights to advertise” on such advertisement spaces.

### FIELD OF THE INVENTION

This invention relates to the fields of computer software and Internet services, and more specifically, the methods of managing the process of advertising on advertisement spaces (hereinafter “ad” spaces) through electronic networks.

### BACKGROUND OF THE INVENTION

Dynamic electronic advertising relates to the process in which advertisements are transmitted to target objects through electronic networks like (but is not limited to) the Internet. Such target objects may be users viewing a web page that is served from a web server that is connected to a network, or electronic billboards that dynamically fetch advertisements from a network source, or other programmatic routines that fetch advertisements for display onto other target systems.

Dynamic electronic advertising is different from traditional television, radio, and print advertising because it leverages on programmatic routines that can determine on the fly, which advertisement to display at a specific point in time, to a specific user, and for a specific period. Traditional advertisements usually require advertisements to be created, staged and scheduled well ahead of time. In contrast, programmatically driven dynamic electronic advertising allows advertisements to be displayed dynamically to different target objects based on a diverse set of real-time, input parameters.

Currently, the largest, most popular medium through which dynamic electronic advertising takes place is the Internet. In this form, it is usually called “online advertising”. The Internet itself is a large, global network that connects and facilitates communication amongst electronic devices and by extension the human users that use such devices.

Advertisers typically show advertisements to Internet users by placing advertisements on the websites that they believe their target audience visit. These websites are typically owned and operated by individuals or organizations that are generally referred to as “publishers” within the advertising industry. The chief objective of most advertisers is to match their ads to the right publisher and by extension to the right audience, and the process of matching ads to the right audience is referred to as “targeting”, within the industry.

To facilitate this objective, several efforts have arisen to help advertisers target their ads accurately. There have been efforts to target ads to a user based on:
(1) Information collected about the user's browsing behavior. This is typically done by placing a textual token called a cookie on the user's computer that allows a server to track their activity as they browse through the Internet. This method is typically called “behavioral targeting”;
(2) The keywords that users type in search engines. This method is typically called “search-based targeting” or “keyword targeting”;
(3) The main keywords that are derived by a computer program that scans the websites that the user visits. This method is also called “keyword targeting”;
(4) The user's geographical location as derived by cross referencing the user's IP (internet protocol) address with a database of IP address to geographic location mappings;
(5) The information available in a log of the user's web browsing activity. This log is called a “click-stream” and it is usually produced by ISPs (Internet Service Providers) and other companies that install specialized software on the user computer to track the user's browsing habits; and
(6) The information provided by publishers on the user's nature and the level of traffic that the publishers' websites attract.

These approaches are common in the sense that a computer program continuously monitors each user and tries to determine the best fit out of all the ads in its repository, or by leveraging on cookies, search keywords, and snooping or spying software to determine what each user is doing. However, several flaws have become apparent.

Firstly, when users share computers or IP addresses, inevitably these methods may interpret different behaviors as one, and as such, dilute the quality and authenticity of their analysis. Furthermore, there are serious privacy concerns about using cookies to track user behavior across multiple unrelated websites. Whilst users typically understand that cookies are useful for managing their session with a single website, tracking them across multiple websites is clearly more contentious.

Keyword targeting in the current implementation is still in its infancy and can often lead to mismatched advertisements due to the lack of rich information from which to determine the context of the keywords.

The prior art typically allow advertisers to (a) place bids for keywords that can be linked to ad spaces, (b) buy rights to advertise on ad spaces based on a fixed or negotiated price through a broker, or (c) buy rights to advertise on ad spaces based on a fixed or negotiated price directly from the publisher.

These approaches have gained a lot of traction in the industry but unfortunately have still not solved some key problems, and in some cases, they have created new problems. The first problem is typically called “click fraud”. Click fraud is the act of deliberately driving up the cost of advertising to the advertiser, whilst simultaneously reducing the benefit that the advertiser derives from such clicks. Advertisers that bid for keywords commit to pay the bid amount for every click, thousand impressions or leads generated by the ad space to which those keywords relate. This creates an economic incentive for some people to artificially generate clicks, impressions or leads from those ad spaces. To fight this problem, methods have been implemented that try to distinguish valid clicks, impressions or leads from invalid ones. However, these methods are at best reactionary and their accuracy is often contested by the victims. By definition, the existence and pervasiveness of click fraud is testament to the shortcomings in these methods.

The second problem created by prior art is lack of transparency. Whilst click fraud typically affects advertisers directly, the lack of transparency problem directly affects publishers. Publishers typically rely on the reports that their broker provides to them on the price for which the rights to their ad spaces were sold, and how many impressions, clicks or leads their ad spaces generated within the advertising period. Without full, unbiased and auditable disclosures, many publishers may not get the best deal from their broker.

The third problem created by the prior art is the lack of fairness. When advertisers negotiate with publishers, there is often no directly comparable reference from which either party can determine the fairness of the price of the trade. Left unchecked, it can create massive disparities in the price at which similar ad spaces are sold and create supply and demand disparities in the online advertising industry.

### SUMMARY OF THE INVENTION

The present invention provides a method, system, and/or apparatus for analyzing advertisement spaces, the environment in which they are located, and the generality of their audience in order to provide analytic data or analytics. The method may further include making the analytics searchable by anyone who wishes to perform research or accurately target advertisements to such ad spaces, and facilitating transparent price discovery and open, many-to-many trading of such advertisement spaces.

One or more embodiments of the present invention are distinct from prior art approaches because one or more embodiments are designed to allow humans to collectively categorize ad spaces (and by extension the related audience), and also allow humans to predetermine precisely where their ads will be placed.

Furthermore, one or more embodiments of the present invention introduce a novel approach to discovering and determining the prices of ad spaces.

One or more embodiments of the present invention allow advertisers and publishers to buy and sell their rights freely in a manner akin to a stock market. This allows the price of an ad space to be ultimately determined by the match between the best price that any user is prepared to buy such rights and the best price that any user is prepared to sell such rights. In at least one embodiment of the present invention, a key distinction is that rights to advertise on ad spaces are traded between multiple users (many-to-many) and not necessarily between advertiser and publisher (one-to-one).

Additionally, in at least one embodiment of the present invention, a key distinction is that buyers of the rights to advertise on an ad space have an option to resell such rights back to the publisher at a prearranged or dynamic price. In other words, the publisher always acts as a buyer (or counterparty to a trade) of last resort for all the advertisement rights that they sell.

Furthermore, pricing, in at least one embodiment is based directly on ad spaces and not keywords and by allowing users to collectively categorize and rate ad spaces (including flagging errant ad spaces that they encounter), and trade all ad spaces freely, it mitigates the effect of click fraud effectively.

An overall objective of one or more embodiments of the present invention is to create a new system for discovering which ad spaces across any electronic network will deliver the best results to advertisers, and for creating a transparent, marketplace for buying and selling the rights to advertise on all ad spaces.

The objective of one or more embodiments of the present invention can be achieved in several connected processes. However, in the interest of brevity, the processes can be categorized into three main systems—(I) Analytics, (II) Search, and (III) Trading.

The (I) Analytics system provides for a set of processes that collect information about each ad space with the aim of creating a set of analytical derivative views (henceforth called Analytics) of the ad space. Primarily, a database is employed to organize “analytics” data of each ad space. The “analytics” data of each ad space includes information, such as, but is not limited to:
(a) The dimensions of the ad space;
(b) Allowable types of advertisement, such as for example, Static Image, Text, Fixed Rich Media, Expandable Rich Media, Video etc;
(c) The payment model for the ad space, i.e. Pay Per Click, Pay Per Thousand Impressions, Pay Per Unique Visitor, or Pay Per Action (or Lead);
(d) One or more Uniform Resource Locators (URLs) that allow users to preview the ad space;
(e) One or more words or phrases (tags) that describe the content or the type of audience that interact with the ad space;
(f) One or more words or phrases (tags) that describe the type of advertisement that should not be displayed on the ad space,
(g) One or more statistics that describe the distribution of the audience by gender, age range, income range, ethnicity, race, sexual preference, language, ethnic group, job or professional qualifications, and other available demographic criteria;
(h) One or more statistics that describe the number of impressions, page views, clicks, leads, average time spent by the audience, distribution of time spent by the audience i.e. very short, short, medium, long, very long, and other traffic statistics. Each set of such statistics may be organized by geographic location i.e. country, region (State or Province), and location (City, Town or Locality);
(i) One or more images or icons that relate to the ad space, web site, or individual or organization that owns or manages the ad space; and
(j) One or more reviews from authorized users.
(k) One or more ratings from authorized users that indicate the user's level of satisfaction with the ad space.

The analytics data, such as information of the types shown in (a)-(k) above can be provided and updated manually by a publisher or automatically by sending periodic updates via an electronic link. However, in order to create a richer set of descriptive information about the ad space, the tags that describe the content to which each ad space is related, can be updated by any authorized user on the system.

Furthermore in order to create a reference point about the past performance of each ad space, each ad space can be rated and reviewed by any authorized user. For example, if an advertiser feels that they have been a victim of click fraud or the publisher has misrepresented the information about their ad space, the ad space rating system allows them to provide valuable feedback to other users. Conversely, ad spaces that meet or exceed advertiser expectations can be rated and reviewed favorably. This community-led accountability is markedly different from prior methods, and when used by a critical mass of users, it has the potential to be immensely effective.

In the (II) search system, one or more embodiments of the present invention provides for a set of processes that connect a user interface to the database of analytics. One or more embodiments of the present invention allow a user to use the user interface to submit a combination of search queries via an electronic link to a computer (server) that can produce a list of ad spaces or a set of “analytics” that match the submitted query. Such search queries can include any combination of the following:
(a) Words or phrases (tags), for example, all ad spaces with tags that match “music, rock, oldies”;
(b) Demographic restrictors e.g. “All ad spaces that attract users in a specific income range e.g. $50,000-$100,000”;
(c) Geographic restrictors e.g. “All ad spaces that attract users in a specific geographical location e.g. “Manhattan, N.Y., USA”;
(d) Performance restrictors e.g. “All ad spaces that have a click through rate above 5%”;
(e) Price restrictors e.g. “All ad spaces that are priced above or below $2 per Thousand Impressions”; and
(f) Predefined groups or named sets e.g. “All ad spaces that are in the Most Popular List, or Most Recently Searched List, or My Watch-list/Favorites”.

On receipt of a search query, the server typically (1) pre-processes the query; (2) interrogates the database to find ad spaces or “analytics” that match the query; (3) optionally ranks the results based on the preferences provided by a user or derived from the search query itself; and (4) formats the result into an extensible Markup Language (XML) format, image or other binary representation as prescribed by the system's settings or the search query.

On receipt of the result from the server, the user interface formats the result into either (1) a visual representation of the icons of each ad space; (2) a tabular representation of part or all of the information received; (3) a tag cloud, which is a visual representation of all the tags on the ad spaces with the higher ranks (where ranks are automatically assigned by the server) shown with greater emphasis (by size or position), or (4) structured rendering of part or all of the information received onto the display.

The (III) trading system provides for a set of processes that allow users to view the real time or delayed market price, and full or partial listing of all the trade orders for one or more ad spaces. Additionally, the processes in this system allow users to submit new trade orders, and amend or cancel existing orders. Finally, the processes in the trading system provide for a set of subsystems that can instantaneously store, match and process the accounting details of orders to buy and orders to sell.

First of all, the user interface can display what is termed a “trade book” for any ad space. This may be similar to the “order book” in stock market terminology but it typically operates differently in this method because it applies to ad spaces exclusively in one embodiment of the present invention. Essentially, the trade book is an ordered listing of all the active buy orders and the sell orders for rights to the ad space. By default, it may be comprised of six columns that show the (1) source of the order to buy i.e. unique identifier of the buyer, (2) quantity of impressions, page views, clicks or leads in the order to buy (3) bid price of the order to buy, (4) ask price of the order to sell (5) quantity of impressions, page views, clicks or leads in the order to sell (6) source of the order to sell i.e. identifier of the seller.

The orders to buy may be listed in descending order with the buy order with the highest bid price on top of the left hand side (first three columns) of the list, whilst the orders to sell may be listed in ascending order with the sell order with the lowest ask price on top of the right hand side (last three columns) of the list.

Furthermore, the sum or average of all the quantities in the orders to buy and sum or average of all the quantities in the orders to sell is displayed prominently. Additionally, the weighted (quantity adjusted) average of all the bid prices and weighted (quantity adjusted) average of all the ask prices is displayed prominently. The aim of this formatting is to provide an instantaneous quantitative and qualitative assessment of the supply and demand equilibrium of the trade orders for the ad space.

Finally, the user interface provides a system for creating and submitting new orders to the server, and managing existing orders.

When the server receives a trade order, it (1) pre-processes the order, (2) stores the order in an in-memory or persistent database, and (3) raises an event to notify a special trade matching subsystem. On receipt of the event, the trade matching subsystem proceeds to match the order with other orders for the same ad space based on a set of rules.

As orders are matched (1) a new market price is set for the ad space to reflect a trade that just took place, (2) rights to advertise on the ad space are transferred from the seller to the buyer, (3) funds for the purchase are debited from the buyer in favor of the seller, and (4) notifications are sent to authorized “listener” routines to commence post trade processing.

After trading, buyer can either (1) exercise the purchased rights by delivering ads on the ad space, or (2) resell the rights to other users repeating the aforementioned processes.

### BRIEF DESCRIPTION OF THE DRAWINGS

FIG. 1 shows a block diagram illustrating the nodes (i.e. entities, processes, interfaces, and displays) and data flow within an analytics system in accordance with an embodiment of the present invention;

FIG. 2 shows a block diagram illustrating the nodes (i.e. entities, processes, interfaces, and displays) and data flow within a search system in accordance with an embodiment of the present invention;

FIG. 3 shows a block diagram illustrating the nodes (i.e. entities, processes, interfaces, and displays) and data flow within a trading system in accordance with an embodiment of the present invention;

FIG. 4 shows a screenshot of an analytics user interface for use in the embodiment of FIG. 1 where content and exclusion tag information can be collected;

FIG. 5 shows a screenshot of an analytics user interface for use in the embodiment of FIG. 1 where a range of acceptable types of advertisement are shown in a select list;

FIG. 6 shows a screenshot of an analytics user interface for use in the embodiment of FIG. 1 where a range of advertisement units (dimensions) as prescribed by the Internet Advertising Bureau are shown in a select list;

FIG. 7 shows a screenshot of an analytics user interface for use in the embodiment of FIG. 1 where a range of payment models for advertisements are shown in a select list;

FIG. 8 shows a screenshot of an analytics user interface for use in the embodiment of FIG. 1 where demographic tuples can be collected;

FIG. 9 shows a screenshot of an analytics user interface for use in the embodiment of FIG. 1 where various analytical tuples on traffic and pricing can be displayed and charted;

FIG. 10 shows a screenshot of an analytics user interface for use in the embodiment of FIG. 1 where geographic tuples can be displayed and charted;

FIG. 11 shows a screenshot of an analytics user interface for use with the embodiment of FIG. 1 where demographic information on a gender distribution of an ad space's audience can be displayed and charted;

FIG. 12 shows a screenshot of an analytics user interface for use with the embodiment of FIG. 1 where demographic information on an age range distribution of an ad space's audience can be displayed and charted;

FIG. 13 shows a screenshot of an analytics user interface for use with the embodiment of FIG. 1 where demographic information on an income range distribution of an ad space's audience can be displayed and charted;

FIG. 14 shows a screenshot of an analytics user interface for use with the embodiment of FIG. 1 where demographic information on the ethnicity distribution of an ad space's audience can be displayed and charted;

FIG. 15 shows a screenshot of a search user interface for use with the embodiment of FIG. 2 where a thumbnail list is displayed;

FIG. 16 shows a screenshot of a search user interface for use with the embodiment of FIG. 2 where a tag cloud is displayed;

FIG. 17 shows a screenshot of a search user interface for use with the embodiment of FIG. 2 where a table view is displayed;

FIG. 18 shows a screenshot of a trade user interface for use with the embodiment of FIG. 3 where a trade book is displayed;

FIG. 19 shows a screenshot of a trade user interface for use with the embodiment of FIG. 3 where a trade order form is displayed alongside a full range of trade order types; and

FIG. 20 shows a screenshot of a trade user interface for use with the embodiment of FIG. 3 where a view for searching and displaying historical trade orders is displayed.

### DETAILED DESCRIPTION OF THE DRAWINGS

One or more embodiments of the present invention provide a method for analyzing, searching for, and trading targeted advertisement (ad) spaces. The description below describes numerous details for creating various embodiments of the present invention. Three major systems of the present invention are described: analytics, search, and trading.

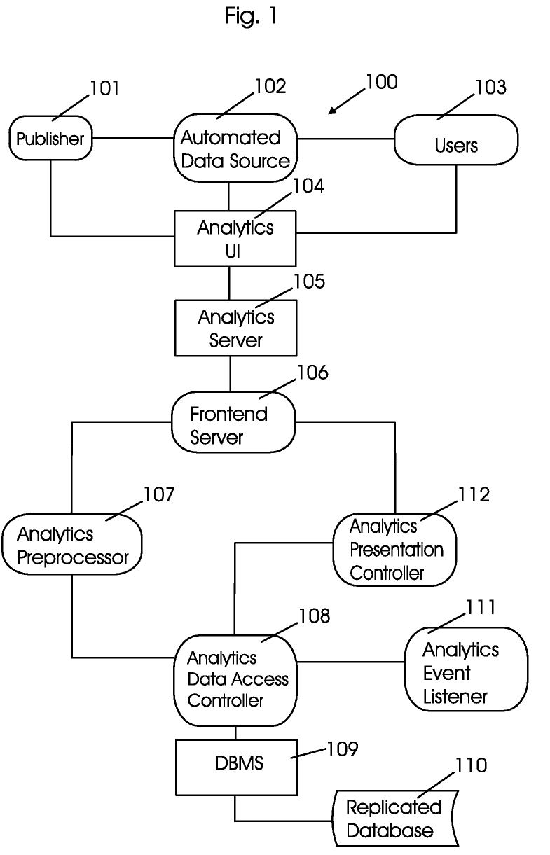

FIG. 1 shows a block diagram 100 illustrating the nodes (i.e. entities, processes, interfaces, and displays) and data flow within an analytics system in accordance with an embodiment of the present invention.

The block diagram 100 shows the publisher 101 entity, automated data source 102 entity, users 103 entity, analytics UI (user interface) 104 interface, analytics server 105 interface, frontend server 106 process, analytics preprocessor 107 process, analytics data access controller 108 process, DBMS (database management system) 109 process, replicated data base 110 process, analytics event listener 111 process, and analytics presentation controller 112 process.

The analytics system as shown by FIG. 1, is comprised of two groups of nodes that encompass the analytics user interface (UI) 104 and the analytics server 106 respectively.

The analytics UI 104 can be implemented as computer software in the form of computer readable code, executed on a general purpose computer or as a general Markup language such as the Hypertext Markup Language (HTML), Wireless Markup Language (WML) or other type of software that can be interpreted by a browser or interpreter. Such computer software will be able to collect input data from the publisher 101, any authorized user 103, automated data source 102 by importing data from a stream of bytes from a file or other computer software.

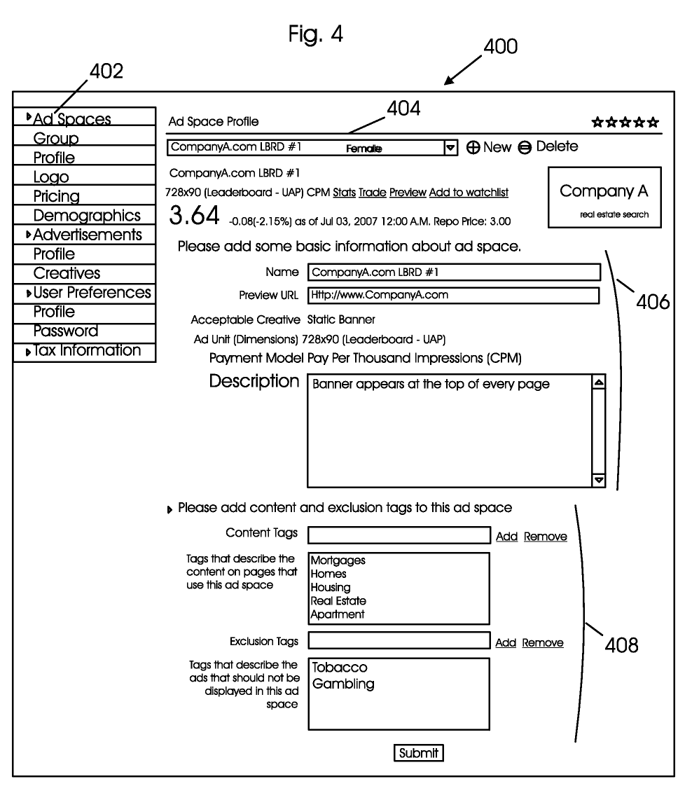

FIG. 4 shows a screenshot or image 400 which can be displayed on (or can be described as being part of or a version of) the analytics user interface 104 for use in the embodiment of FIG. 1 where content and exclusion tag information can be collected.

The image 400 includes section 402 which includes fields or links for “Ad spaces”, “Group”, “Profile”, “Logo”, “Pricing”, “Demographics”, “Advertisements”, “Profile”, “Creatives”, “User Preferences”, “Profile”, “Password”, and “Tax Information”. When a user clicks on one of the fields or links in section 402 such as by using a computer mouse, the analytics UI 104 will show a collection of input controls that can be used to collect analytical information that is related to the clicked category.

The image 400 also includes section 404 which refers to a select list that may be used to group a collection of related ad spaces by name or other identifier. When a user chooses an entry from the select list, the analytics UI 104 will display information and input controls that are related to the selected ad space.

The image 400 also includes section 406 which refers to basic information about an ad space, which can be typed in by a user using a computer keyboard which may be part of the analytics UI 104. Section 406 may include a name of a web site, such as CompanyA.com LBRD #1, and a preview URL which is shown. Section 406 may also include the identification of the type of ad, such as “Static Banner”, the dimensions of the ad, such as 728×90 pixels and/or a well known identifier for the dimension, such as “Leaderboard UAP (Universal Ad Package)”, which also resolves to 728×90 pixels. Section 406 may also include the payment model. In this case the user is paying per thousand impressions. Section 406 may also include a description that provides more information about the ad space, such as how it is positioned, the number of pages or locations on which it is displayed, and other more descriptive information that is not ordinarily captured elsewhere in the analytics UI 104.

The image 400 also may include section 408. Section 408 may include content tags and exclusion tags related to this ad space. A user can type in the box next to the “Content Tags” designation and then click on “Add” or “Remove” next to that box to add or remove the typed in item as a content tag. Using content tags has the effect of categorizing the ad space under the content tags that are specified and as a consequence, allows other users to find the ad space by specifying exact or similar tags or keywords in the search UI 202.

Referring to section 408 a user can also type in the box next to the “Exclusion Tags” designation and then click on “Add” or “Remove” next to that box to add or remove the typed in item as an exclusion tag. Using exclusion tags has the effect of indicating to the analytics system 100, the search system 200 and the trade system 300 that the ad or ads that are related to the specified exclusion tags should not be matched or allowed to show on the ad space.

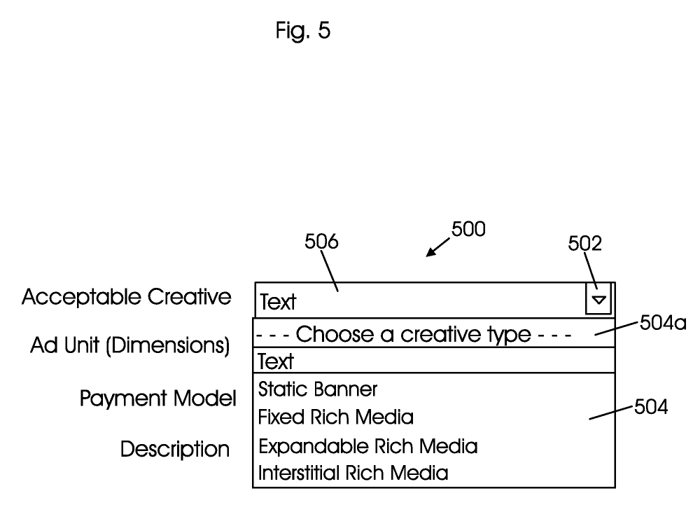

FIG. 5 shows a screenshot or image 500 which can be displayed on (or can be described as being part of or a version of) the analytics user interface 104 for use in the embodiment of FIG. 1 where a range of acceptable types of advertisement are shown in a select list. Specifically, it may be shown in the section 406 of image 400 shown in FIG. 4 if the user has the access privileges to edit the acceptable creatives setting of the ad space. A user can use a computer mouse to click on the pull down menu bar 502, in order to display a list 504 of types of advertisements, which in this example includes “Text”, “Static Banner”, “Fixed Rich Media”, “Expandable Rich Media”, and “Interstitial Rich Media”. The user can then click on one of the types of advertisements. In the example of FIG. 5, a user has clicked on “Text”, which is now highlighted by box 504a. When the user selects the type of advertisement, it also will be displayed in field 506 as shown in the example of FIG. 5.

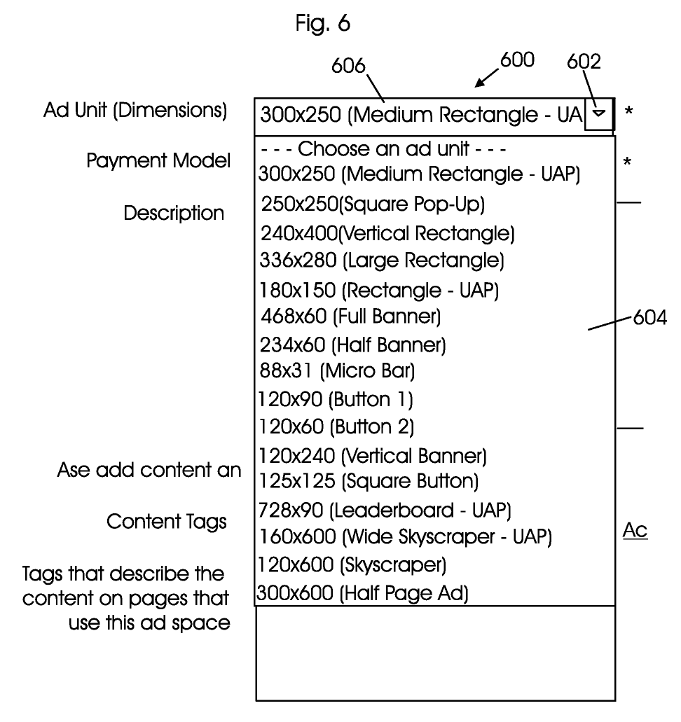

FIG. 6 shows a screenshot or image 600 which can be displayed on (or can be described as being part of or a version of) the analytics user interface 104 for use in the embodiment of FIG. 1 where a range of advertisement units (dimensions) as prescribed by the Internet Advertising Bureau are shown in a select list. Specifically, it may be shown in the section 406 of image 400 shown in FIG. 4 if the user has the access privileges to edit the ad unit setting of the ad space. A user can use a computer mouse to click on the pull down menu bar 602, in order to display a list 604 of types of ad units, such as a particular size or style of ad unit. In this example, the user has clicked on the ad unit “300×250 (Medium Rectangle—UAP)”, where UAP means Universal Ad Package. When the user selects the type of ad unit it also is displayed in field 606.

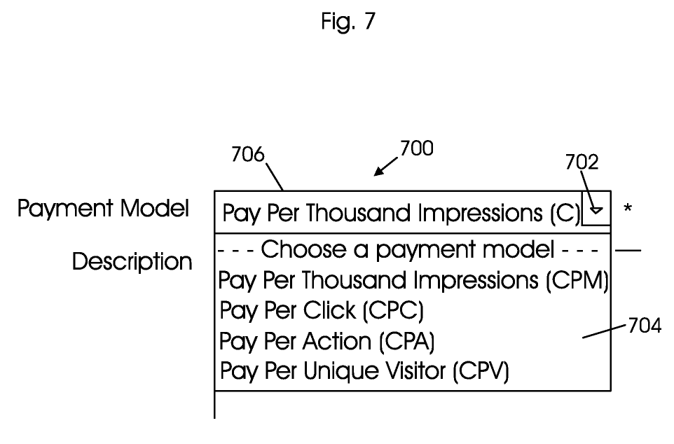

FIG. 7 shows a screenshot or image 700 which can be displayed on (or can be described as being part of or a version of) the analytics user interface 104 for use in the embodiment of FIG. 1 where a range of payment models for advertisements are shown in a select list. Specifically, it may be shown in the section 406 of image 400 shown in FIG. 4 if the user has the access privileges to edit the payment model setting of the ad space. A user can use a computer mouse to click on the pull down menu bar 702, in order to display a list 704 of types of payment models. In this example, the user has clicked on the payment model of “Pay Per Thousand Impressions (CPM)”. When the user selects the type of payment model it also is displayed in field 706.

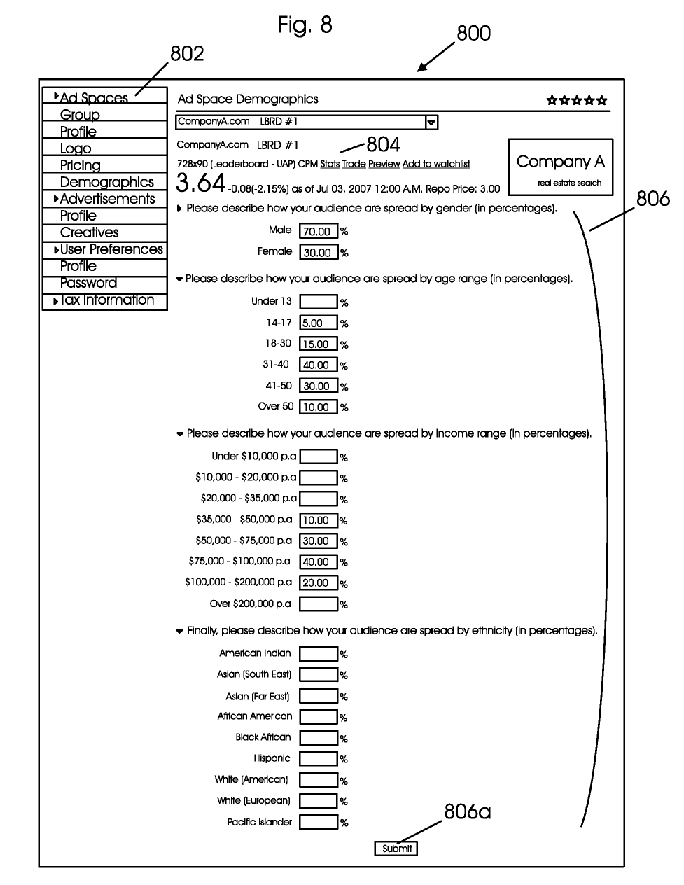

FIG. 8 shows a screenshot or image 800 which can be displayed on (or can be described as being part of or a version of) the analytics user interface 104 for use in the embodiment of FIG. 1 where demographic tuples can be collected. The image 800 includes sections 802 and 806 which may be similar to or identical to sections 402 and 404, respectively, of image 400 shown in FIG. 4, except that FIG. 8, shows a title of “Ad Space Demographics” while FIG. 4 shows a title of “Ad Space Profile”. A user can cause the image 800 to be displayed on the computer monitor or interface 104 by selecting the link for “Demographics” shown in sections 402 and 802.

The image 800 also includes section 806 which shows demographics data prompts or directives. A user can respond to these directives by entering percentage data in the appropriate boxes concerning gender, age, income, and ethnicity demographics of the ad's potential target audience. After the demographics data is entered it can be submitted to analytics server 105 in FIG. 1 by a user clicking on the submit button or field 806a.

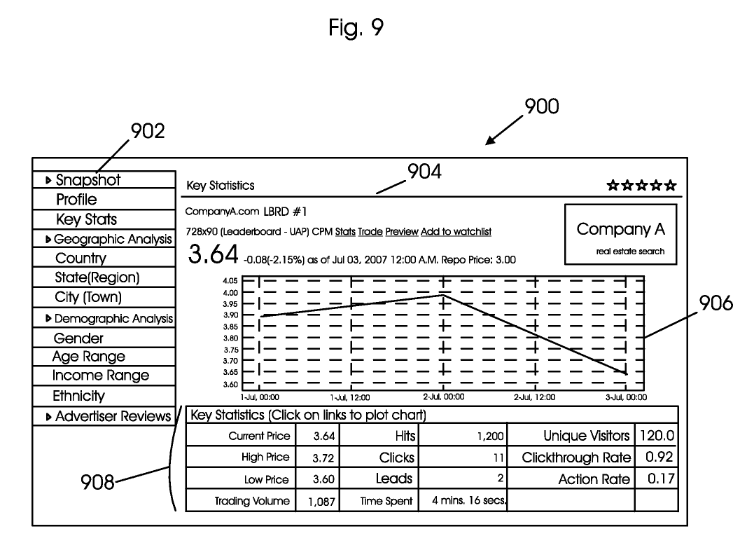

FIG. 9 shows a screenshot or image 900 which can be displayed on (or can be described as being part of or a version of) the analytics user interface 104 for use in the embodiment of FIG. 1 where various analytical tuples on traffic and pricing can be displayed and charted. The image 900 includes section 902 which includes the fields or links for “Snapshot”, “Profile”, “Key Stats”, “Geographic Analysis”, “Country”, “State(Region)”, “City(Town)”, “Demographic Analysis”, “Gender”, “Age Range”, “Income Range”, “Ethnicity”, and “Advertiser Reviews”. When a user clicks on one of the fields or links in section 908 such as by using a computer mouse, a new chart or other visual representation of the historical statistics that pertain to the clicked link or field will be displayed in section 906. For example, section 906 depicts a chart of the historical statistics that relate to the price of the ad space as if the current price link had been clicked upon.

The image 900 also includes section 904 which is a snapshot of key information about the selected ad space which includes (but is not limited to) its identification, price, rating, and logo, and title of the view. The image 900 further includes section 906 which is a time chart of the price of the ad space (or specifically, the rights to advertise on the ad space) and section 908 which is a tabular representation of various key statistics of the ad space. It includes (but is not limited to):
(1) Current Price—this is the prevailing price of the rights to advertise on the ad space
(2) High Price—this is the highest price that the rights to advertise on the ad space were traded within the preceding 24 hours or other system defined time period.
(3) Low Price—this is the lowest price that the rights to advertise on the ad space were traded within the preceding 24 hours or other system defined time period.
(4) Trading Volume—this is the total number of vested rights (to advertise) (where the vested rights are the impressions, clicks, unique visitors, or leads) that were traded in the most recently recorded trade on the ad space. It could also record the cumulative number or vested rights traded on the ad space within the preceding 24 hours or other system defined time period.
(5) Hits (Impressions)—this is the total or average number of times that an advertisement was displayed on the ad space within the preceding 24 hours or other system defined time period.
(6) Clicks—this is the total or average number of times that an advertisement that was displayed on the ad space was clicked within the preceding 24 hours or other system defined time period.
(7) Leads—this is the total or average number of times that an advertisement that was displayed on the ad space resulted in a predefined (non-click) action within the preceding 24 hours or other system defined time period.
(8) Time spent—this is the total or average time spent by the audience that viewed the ad space within the preceding 24 hours or other system defined time period.
(9) Unique Visitors—this is the total or average number of unique visitors that were recorded on the ad space within the preceding 24 hours or other system defined time period.
(10) Click through Rate—this is a ratio or percentage that is derived by dividing the total or average number of clicks by the total or average number of impressions that were recorded on the ad space within the preceding 24 hours or other system defined time period.
(11) Conversion (or Action) Rate—this is a ratio or percentage that is derived by dividing the total or average number of leads by the total or average number of impressions that were recorded on the ad space within the preceding 24 hours or other system defined time period.

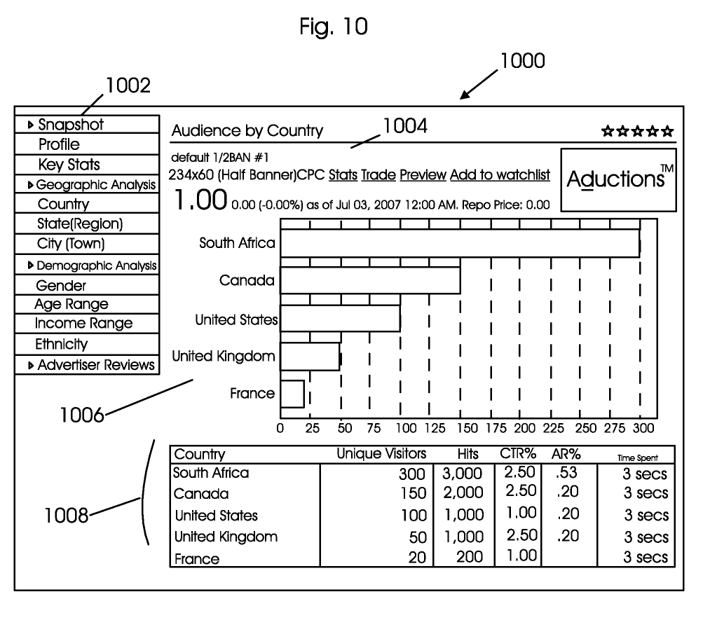

FIG. 10 shows a screenshot or image 1000 which can be displayed on (or can be described as being part of or a version of) the analytics user interface 104 for use in the embodiment of FIG. 1 where geographic tuples can be displayed and charted. The image 1000 includes section 1002 which may be similar or identical to the section 902 in FIG. 9.

The image 1000 also includes section 1004 which is a snapshot of key information about the selected ad space which includes (but is not limited to) its identification, price, rating, and logo, and title of the view. The image 1000 further includes section 1006 which is a bar chart of the number of visitors from various countries to a web site or to an advertisement on the internet. The image 1000 further includes section 1008 which is a tabular representation of the visitors, hits, click through rate (CTR %), and Conversion (or Action) Rate (AR %), and time spent, by various visitors from various countries concerning an ad or web site. The tabular representation allows users to quickly compare and sort traffic statistics from various countries.

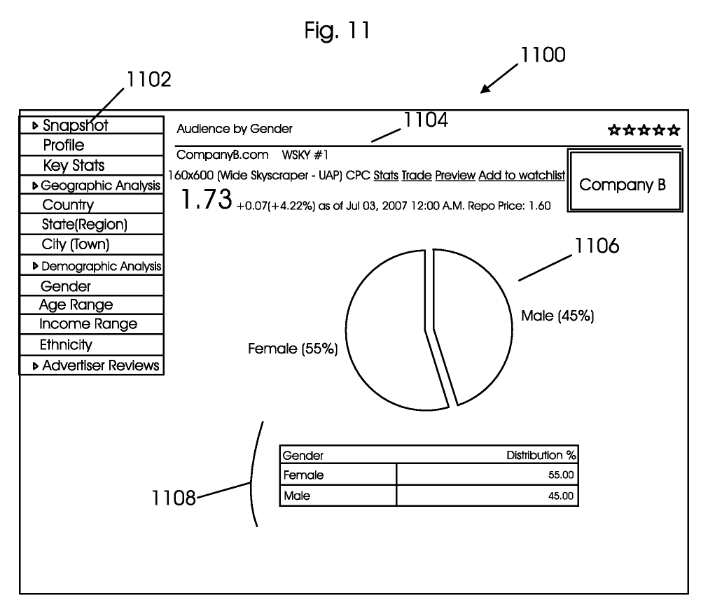

FIG. 11 shows a screenshot or image 1100 which can be displayed on (or can be described as being part of or a version of) the analytics user interface 104 for use in the embodiment of FIG. 1 where demographic information on a gender distribution of an ad space's audience can be displayed and charted. The image 1100 includes section 1102 which may be similar or identical to the section 902 in FIG. 9 and section 1002 in FIG. 10.

The image 1100 also includes section 1104 which is a snapshot of key information about the selected ad space which includes (but is not limited to) its identification, price, rating, and logo, and title of the view. The image 1100 further includes section 1106 which is a pie chart of the percentage of female and male visitors from to a web site or to an advertisement on the internet. The image 1100 further includes section 1108 which is a tabular representation of the percentage of female and male visitors to a web site or an advertisement on a web site.

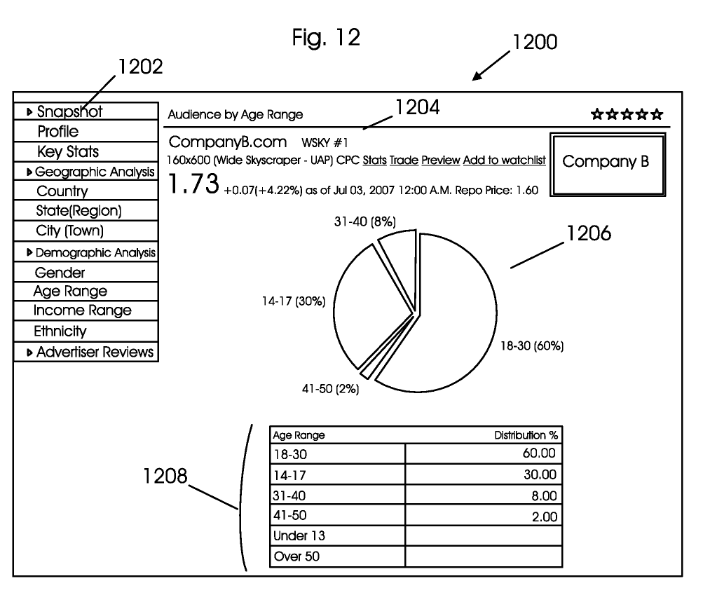

FIG. 12 shows a screenshot or image 1200 which can be displayed on (or can be described as being part of or a version of) the analytics user interface 104 for use in the embodiment of FIG. 1 where demographic information on an age range distribution of an ad space's audience can be displayed and charted. The image 1200 includes section 1202 which may be similar or identical to the section 902, 1002, and 1102 in FIGS. 9-11, respectively.

The image 1200 also includes section 1204 which is a snapshot of key information about the selected ad space which includes (but is not limited to) its identification, price, rating, and logo, and title of the view. The image 1100 further includes section 1206 which is a pie chart of the percentage of different age groups of visitors to a web site or to an advertisement on the internet. The image 1200 further includes section 1208 which is a tabular representation of the percentage of different age groups of visitors to a web site or an advertisement on a web site.

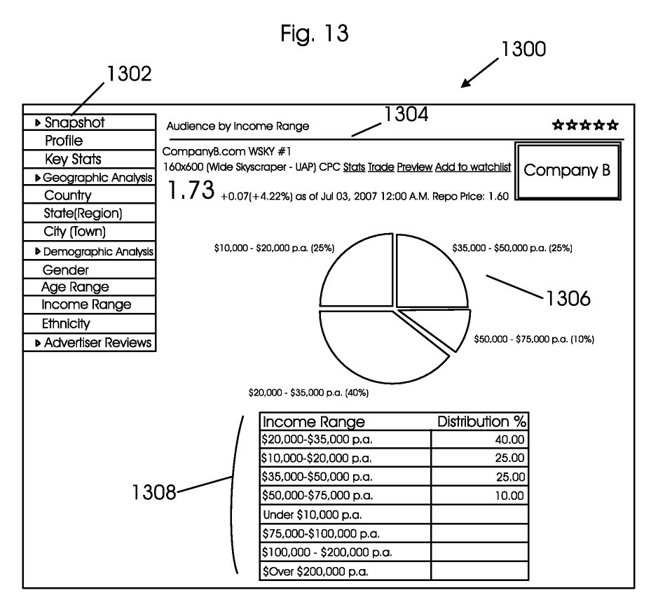

FIG. 13 shows a screenshot or image 1300 which can be displayed on (or can be described as being part of or a version of) the analytics user interface 104 for use in the embodiment of FIG. 1 where demographic information on an income range distribution of an ad space's audience can be displayed and charted. The image 1300 includes section 1302 which may be similar or identical to the section 902, 1002, 1102, and 1202 in FIGS. 9-12, respectively.

The image 1300 also includes section 1304 which is a snapshot of key information about the selected ad space which includes (but is not limited to) its identification, price, rating, and logo, and title of the view. The image 1300 further includes section 1306 which is a pie chart of the percentage of different income ranges of visitors to a web site or to an advertisement on the internet. The image 1300 further includes section 1308 which is a tabular representation of the percentage of different income ranges of visitors to a web site or an advertisement on a web site.

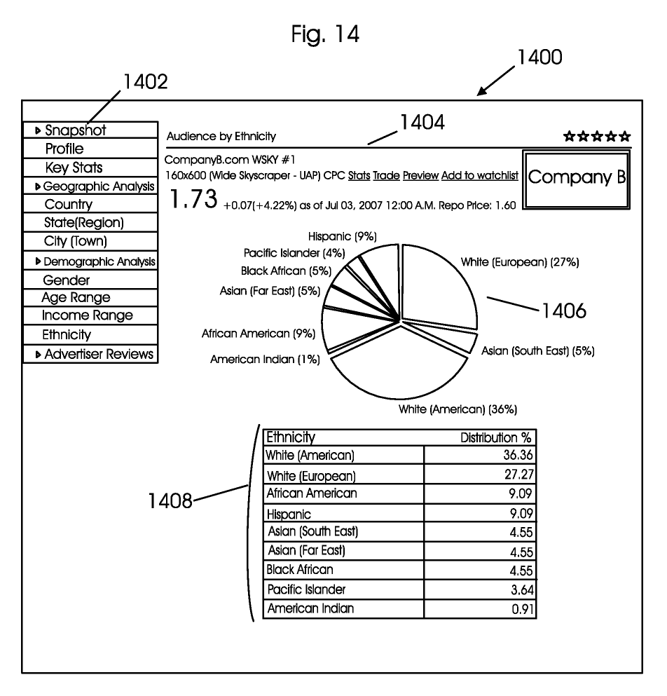

FIG. 14 shows a screenshot or image 1400 which can be displayed on (or can be described as being part of or a version of) the analytics user interface 104 for use in the embodiment of FIG. 1 where demographic information on ethnicity of an ad space's audience can be displayed and charted. The image 1400 includes section 1402 which may be similar or identical to the section 902, 1002, 1102, 1202, and 1302 in FIGS. 9-13, respectively.

The image 1400 also includes section 1404 which is a snapshot of key information about the selected ad space which includes (but is not limited to) its identification, price, rating, and logo, and title of the view. The image 1400 further includes section 1406 which is a pie chart of the percentage of different ethnicities of visitors to a web site or to an advertisement on the internet. The image 1400 further includes section 1408 which is a tabular representation of the percentage of different ethnicities of visitors to a web site or an advertisement on a web site.

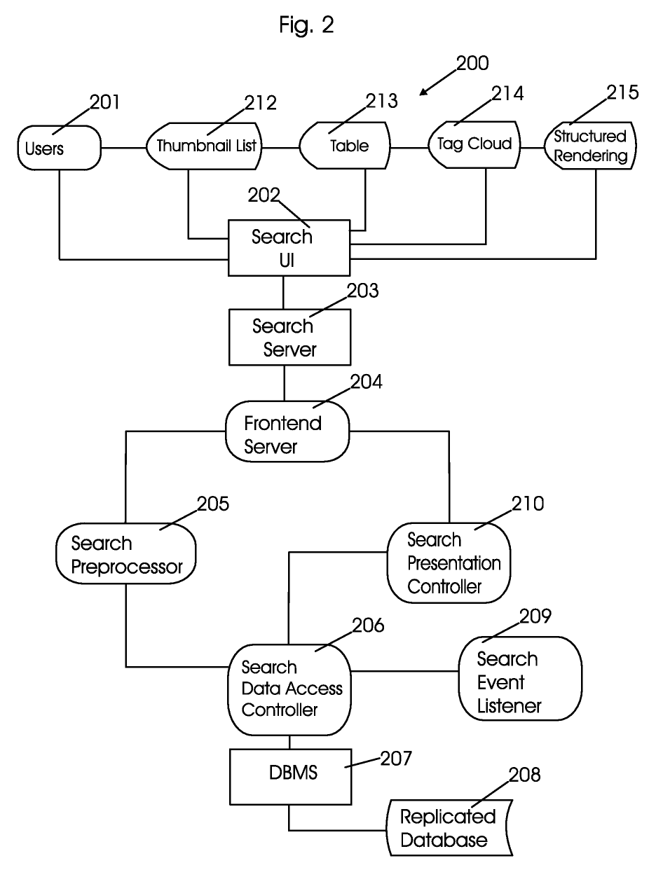

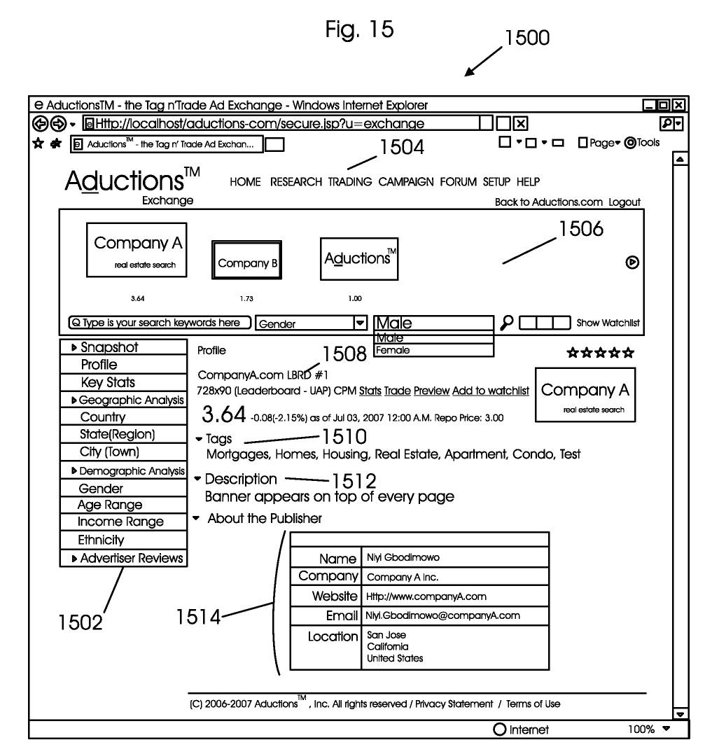

FIG. 15 shows a screenshot or image 1500 which can be displayed on (or can be described as being part of or a version of) the analytics user interface 104 for use in the embodiment of FIG. 1 and the search user interface 202 in FIG. 2 where a thumbnail list 212, is displayed. The image 1500 includes section 1502 which may be similar or identical to the section 902, 1002, 1102, 1202, 1302, and 1402 in FIGS. 9-14, respectively.

The image 1500 also includes section 1504 which show links that allow a user to access various parts of the analytics user interface 104, search user interface 202, and trade user interface 303. It also includes section 1508 which is a snapshot of key information about the ad space which includes (but is not limited to) its identification, price, rating, and logo, and title of the view. It also includes section 1510, 1512 and 1514 which show the content tags, description and publisher details of the ad space respectively. Section 1506 shows an embodiment of the thumbnail list 212 in FIG. 2 which shows the logos and clickable links of the ad spaces that are sent back to the search user interface 202 when a search query is sent to search server 203, both in FIG. 2.

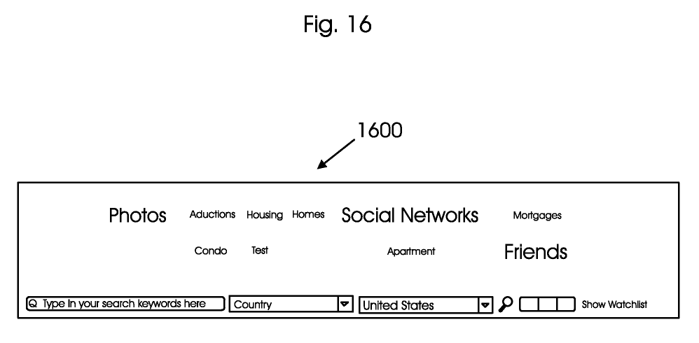

FIG. 16 shows a screenshot or image 1600 which can be displayed on (or can be described as being part of or a version of) the search user interface 202 for use in the embodiment of FIG. 2 where a tag cloud is displayed. Specifically, the embodiment shows tag cloud 214 which is a visual representation of the content tags of the ad spaces of the ad spaces that are sent back to the search user interface 202 when a search query is sent to search server 203, both in FIG. 2.

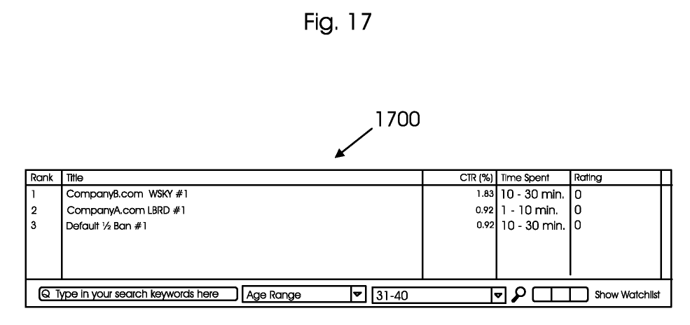

FIG. 17 shows a screenshot or image 1700 which can be displayed on (or can be described as being part of or a version of) the search user interface 202 for use in the embodiment of FIG. 2 where a table view is displayed. Specifically, the embodiment shows table 213 in FIG. 2 which is a tabular representation of the attributes or statistics of the ad spaces of the ad spaces that are sent back to the search user interface 202 when a search query is sent to search server 203, both in FIG. 2.

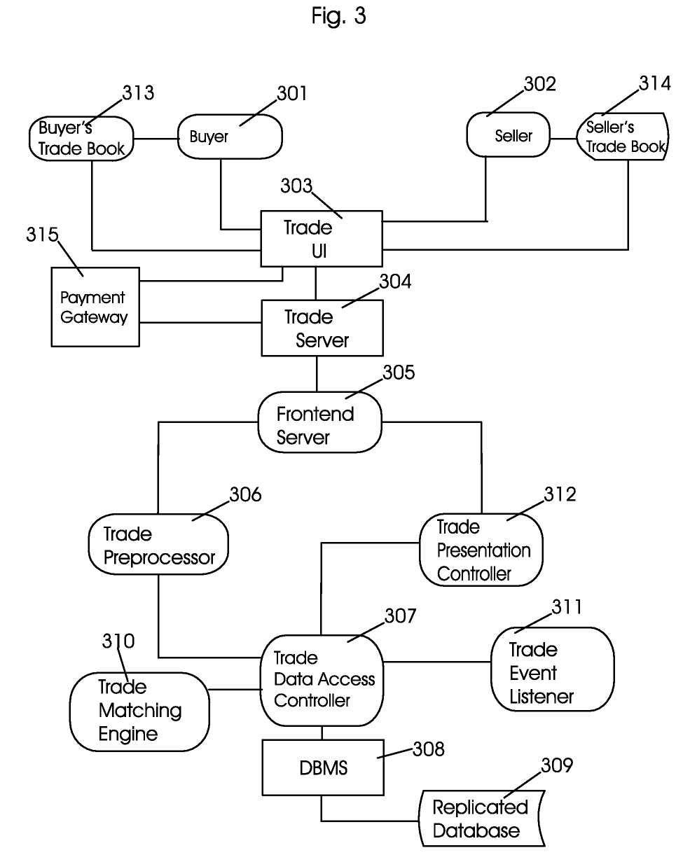

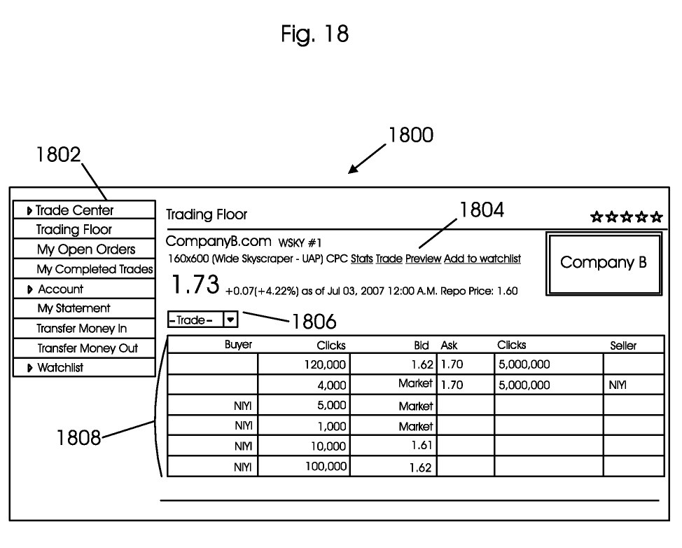

FIG. 18 shows a screenshot or image 1800 which can be displayed on (or can be described as being part of or a version of) the trade user interface 303 for use in the embodiment of FIG. 3 where a trade book is displayed. Image 1800 includes sections 1802, 1804, 1806, and 1808. The image 1800 includes section 1802 which may be similar or identical to the section 902, 1002, 1102, 1202, 1302, and 1402 in FIGS. 9-14, respectively.

The image 1800 also includes section 1804 which is a snapshot of key information about the selected ad space which includes (but is not limited to) its identification, price, rating, and logo, and title of the view. The image 1800 further includes section 1806 which a pull down control that allows the user to select the type of trade order that they want to create. The image 1800 further includes section 1808 which is a tabular representation of the trade book of the selected ad space. In the trade book, the rows in the first three columns show the identifier of the buyer, required trade volume i.e. vested rights (where the vested rights are the impressions, clicks, unique visitors, or leads sought) and price for all the bids (buy orders), whilst the rows in the last three columns show the identifier of the seller, offered trade volume i.e. vested rights (where the vested rights are the impressions, clicks, unique visitors, or leads offered) and price for all the asks (sell orders).

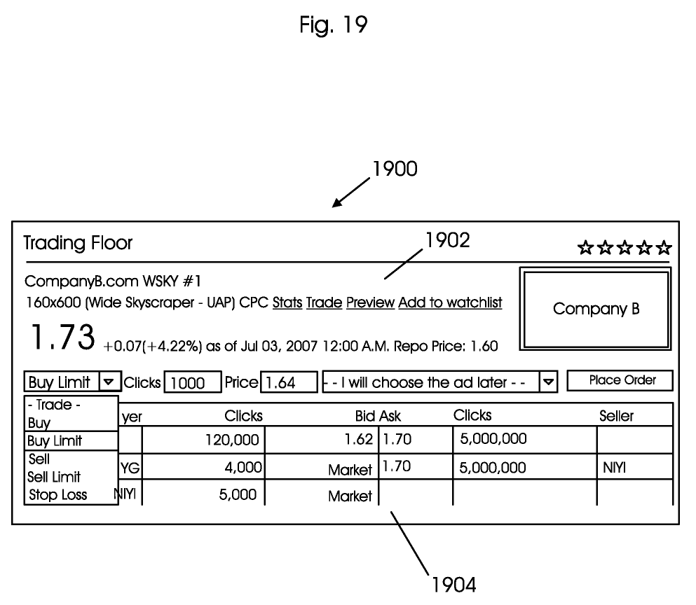

FIG. 19 shows a screenshot or image 1900 which can be displayed on (or can be described as being part of or a version of) the trade user interface 303 for use in the embodiment of FIG. 3 where a trade order form is displayed alongside a full range of trade order types. Image 1900 includes sections 1902 which is a snapshot of key information about the selected ad space which includes (but is not limited to) its identification, price, rating, and logo, and title of the view. The image 1900 also includes section 1904 which may be similar or identical to section 1808 in FIG. 18. However, section 1904 shows further detail on the trade order form including input controls for capturing the trade volume, preferred trade price, a pull down list of all the ads that the user is allowed to use and a button that when clicked sends the details of the trade order to the trade server 304 in FIG. 3.

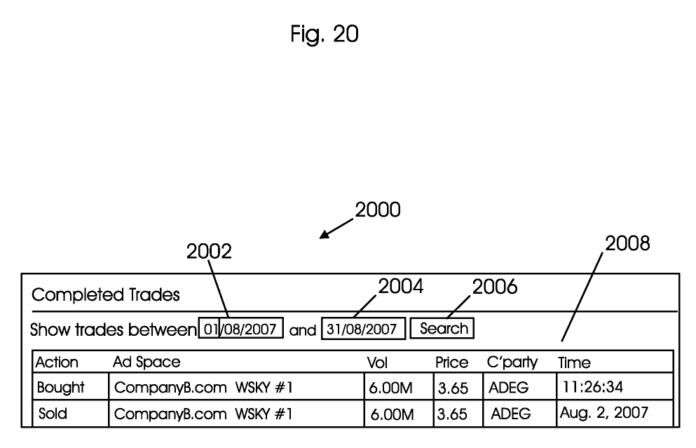

FIG. 20 shows a screenshot or image 2000 which can be displayed on (or can be described as being part of or a version of) the trade user interface 303 for use in the embodiment of FIG. 3 where a view for searching an displaying an historical trade order or trade transaction is displayed. Image 2000 includes sections 2002 and 2004 which show input controls for accepting the lower and upper bound of the date range in which all the trade orders or trade transactions will be shown. Image 2000 also includes section 2006 which shows a button that when clicked sends the details of the search query to the trade server 304 in FIG. 3. Image 2000 also includes section 2008 which shows a tabular representation of the trade orders or trade transactions that are returned after a search is conducted. Each row represents a different trade order or trade transaction and the columns show (but are not limited to) the type of trade action—Bought or Sold, name of the ad space, trade volume, trade price, name of the other party to the trade, and the time of the trade.

The definition of the input data to be provided to the computer software of analytics UI (User interface) 104 can be as follows:
(1) Dimensions of the ad space: In its most basic form, this can be represented by a reference number or one or more characters that represent one of the Interactive Advertising Bureau (IAB) standard advertisement unit types. The information can also be collected as arbitrary integer or floating point dimensions that comprise the width and height of the ad space in pixels, centimeters, inches, meters or any other unit of measurement. As shown in FIG. 6, the information may be collected through a text input control or a drop down select list.
(2) Allowable types of advertisements: As shown in FIG. 5, the domain (or set) of allowable types of advertisements may include:
   (a) Static Image—typically JPEGs, non-animated GIFs, PNG, BMP (Bitmap), or any other image format that can be rendered on a computer screen or electronic billboard;
   (b) Text—a string of characters that purvey the message of an advert;
   (c) Fixed Rich Media—animated images or complex animation of multimedia components that may or may not respond to user interaction. However, the restriction here is that the object does not dynamically resize itself;
   (d) Expandable Rich Media—This the same as Fixed Rich Media, but the object can resize itself dynamically;
   (e) Video—A media type that loads and plays a video stream in the ad space.

Information concerning the allowable types of advertisements can be collected through a text input control or a drop down select list.

(3) Payment Model for the ad space: As shown in FIG. 7, the domain (or set) of payment models include
(a) Pay Per Click—Specifies that the ad space will be priced on every click and Advertisers will be charged for every valid click generated.
(b) Pay Per Thousand Impressions—Specifies that the ad space will be priced on every thousand impressions and Advertisers will be charged for every thousand impressions generated.
(c) Pay Per Unique Visitor—Specifies that the ad space will be priced on every unique visitor and Advertisers will be charged for every unique visitor that views their ad. For clarity, in one embodiment, a unique visitor is a unit of traffic that is inactive for at least 1 hour between successive visits. However, the time period may be different in other embodiments of this invention.
(d) Pay Per Action (or Lead)—Specifies that the ad space will be priced on every predefined action or lead and Advertisers will be charged for every one of such actions or leads generated.

This information can be collected through a text input control or a drop down select list.

(4) Preview URLs: This will be relative or absolute Uniform Resource Locator (URLs) that can allow a user to preview the ad space in action. The URL could point to an active web page, a document (or image) that shows a representation of the ad space. The aim is to give users an indication of the positioning of the ad space and other visual representation of the environment in which the ad space is located. One or more preview URLs can be collected through a text input control.

(5) Content Tags: Content Tags are words or short phrases that describe the content or type of the environment in which the ad space is located. One or more embodiments of the present invention allow the publisher 101 or any authorized user to ascribe one or more Content Tags to each ad space. The Content Tags are collated together and can be used to classify each ad space or allow users to search for ad spaces by specifying exact or similar tags.

Before each Content Tag is ascribed to an ad space, a cross reference is made against an in-memory, local or remote WordNet (or similar) database. The WordNet database is a collection of words that have been grouped into sets of synonyms, and in which the semantic relationships between the various synonym sets have been recorded. The aim is to automatically establish the synonyms, hyponyms, and a plurality of senses of the noun, verb, and adjective forms of each Content Tag. The product of the cross reference is a normalized representation of the Content Tag. This will allow users to match the same Content Tag by specifying any of its several forms.

For example, the word “homes” could produce the following:

The noun home has at least 9 definitions or senses:
(a) home, place—(where you live at a particular time; “deliver the package to my home”; “he doesn't have a home to go to”; “your place or mine?”);
(b) dwelling, home, domicile, abode, habitation, dwelling house—(housing that someone is living in; “he built a modest dwelling near the pond”; “they raise money to provide homes for the homeless”);
(c) home—(the country or state or city where you live; “Canadian tariffs enabled United States lumber companies to raise prices at home”; “his home is New Jersey”);
(d) home—(an environment offering affection and security; “home is where the heart is”; “he grew up in a good Christian home”; “there's no place like home”);
(e) home, nursing home, rest home—(an institution where people are cared for; “a home for the elderly”)
(f) base, home—(the place where you are stationed and from which missions start and end);
(g) family, household, house, home, menage—(a social unit living together; “he moved his family to Virginia”; “It was a good Christian household”; “I waited until the whole house was asleep”; “the teacher asked how many people made up his home”);
(h) home plate, home base, home, plate—((baseball) base consisting of a rubber slab where the batter stands; it must be touched by a base runner in order to score; “he ruled that the runner failed to touch home”); and
(i) home—(place where something began and flourished; “the United States is the home of basketball”).

The plurality of senses represents an ambiguity in the meaning of the Content Tag. A user of the users 103 of FIG. 1, or publisher 101 of FIG. 1 could then manually resolve the ambiguity by choosing one or more contexts that can assist the analytics server 105 in creating a normalized form of the Content Tag.

One or more Content Tags can be collected through a text input control.

(6) Exclusion Tags are similar to Content Tags in the sense that they are words or phrases that describe an item or concept. However, rather than describing the environment of the ad space, they describe the type of advertisements, advertisers or overt or subliminal messages that should not be presented through the ad space. Exclusion Tags may be normalized in the same way that Content Tags are normalized to resolve ambiguities. Another important distinction from Content Tags is that in one embodiment only publishers, such as publisher 101 may specify Exclusion Tags.

For example, if the publisher 101 of FIG. 1 specifies an exclusion tag called “gambling”, the publisher 101 is explicitly giving a directive to the analytics server 105 to restrict all forms of gambling related advertisements from the ad space.

One or more exclusion tags can be collected through a text input control, shown in FIG. 4.

(7) demographic tuples are floating point percentages that describe the distribution of the audience that view the ad space. FIG. 8 shows how the demographic tuples may be captured in analytics UI 104 in FIG. 1. FIGS. 11, 12, 13, and 14 show how the demographic tuples may be displayed in charts on a computer monitor, such as on analytics UI 104 of FIG. 1. The tuples are grouped by the type of demographic. The types include but are not limited to
(a) gender —male, female;
(b) age range—Under 13, 14-17, 18-30, 31-41, 41-50, 51-60, and Over 60;
(c) income range—under $10,000, $10,000-$20,000, $20,000-$35,000, $35,000-$50,000, $50,000-$75,000, $75,000-$100,000, $100,000-$200,000, and over $200,000;
(d) race—various racial groups;
(e) sexual preference—heterosexual, homosexual, or bisexual;
(f) language—various global languages;
(g) ethnic group—various ethnic groups; and
(h) job or professional qualification—all known job types.

For each demographic type, a set of percentages that describe the audience distribution may be collected from the publisher 101 using a text input or slider control, or from automated data source 102, then transmitted to the analytics server 105 of FIG. 1 e.g. male—60%, female—40%. If the sum of distinct percentages for any one demographic type is greater than 100%, the percentages will be normalized to a total sum of 100% i.e. if 60% and 50% is entered, the first percentage will become 54.55% i.e. (60%/(60%+50%)) whilst the second percentage will become 45.45% i.e. (50%/(60%+50%)).

(8) geographic tuples: Geographic tuples are groups of information that describe the traffic that visit the environment in which an ad space is located within a specific period of time. The tuples consist of
(a) number of impressions;
(b) number of page views;
(c) number of unique visitors;
(d) number of clicks generated;
(e) number of leads generated;
(f) average time spent by visitors; and
(g) distribution of visitors by time spent: (i) very short stay i.e. 0 sec-30 sec; (ii) short stay i.e. 30 sec-5 min; (iii) medium stay i.e. 5 min-20 min; (iv) long stay—20 min-45 min; and(v) very long stay—45 min. or more.

Each tuple is time-stamped and organized by geographic location i.e. country, region (state or province), and location (city, town or locality). For example, at a given point in time t, there may exist a tuple t(T) that contains all the aforementioned information on the traffic that visited the ad space since a previous tuple t-1 (T) was generated.

FIG. 9 and FIG. 10 show how these tuples may be displayed by or on analytics UI 104 of FIG. 1. The tuples are loaded from the replicated database 110 in analytics server 105 in FIG. 1.

The tuples may be generated by importing click stream log files, or directly interfacing with some specialist software that can monitor and generate the required information.

(8) Images and Icons: One or more thumbnail images can also be attributed to each ad space. The images can be imported from the file system on the publisher's computer or publisher 101 or loaded with a URL. If configured to do so, the images may be validated to ensure that they meet specific width and height restrictions and are also acceptable image formats. If multiple images are submitted, one of them will be designated as the primary logo for the ad space. The images may be stored in database 110 shown in FIG. 1, distributed file system, which may be on the same storage network as database 110, or in-memory data map on the analytics server 105. Furthermore, a URL that maps to the image will be generated and stored in database 110 in FIG. 1 as a universal reference to the image.

(9) Ratings and reviews: Ratings are integer values in a fixed range (which may be 1-5 in one embodiment) that can be assigned by any authorized user to an ad space. The ratings indicate the user's level of satisfaction with the ad space. Typically, the number 1 represents the lowest rating whilst the number 5 represents the highest rating. Visually, each rating may be represented by a small icon e.g. a star or bullet point and a software code that allows users to specify their ratings just by clicking on the appropriate icon. As ratings are submitted by the users, a total number of ratings submitted and an average of all the ratings is stored in database 110 of FIG. 1. The average of all the ratings will be designated as the primary (official system) rating for the ad space.

In addition to the ratings, the system may present a text input control in analytics UI 104 similar to the implementation in image 400 shown in FIG. 4 into which users can type a short review of the ad space, after which, each review will be time-stamped and ascribed to the ad space for which it was written. All the reviews can be collated together, sorted, formatted and made accessible to users via a User Interface, such as analytics UI 104 similar to the implementation in or as used in image 400 FIG. 4. For example, the reviews could be displayed in HTML format on a web browser.

Prior to transmitting the information to the analytics server 105, the analytics UI 104 may validate the data against a set of predefined rules. For example, the analytics UI 104 may check the bounds of the integer and floating point values, check the format of any dates, email addresses, URLs, or strings, validate XML data against applicable XML schemas, validate the existence of referenced objects, and perform other sanity checks. If there is an error, an exception may be raised and a descriptive error message or error code will be sent to the source of the data, or stored in a log file that may be managed by one or more analytics event listener 111 in FIG. 1 for further review. Alternatively, the analytics UI 104 may delegate part of all of the validation to the analytics pre-processor 107 described below.

If all the input data passes validation with the analytics UI 104, the input data will be transmitted to one or more nodes in a cluster of analytics servers 105. The analytics servers 105 may be implemented as software components running on general purpose or specialized server computers.

Typically, each analytics server 105 in the cluster is comprised of a frontend server 106, an analytics pre-processor 107, an analytics presentation controller 112, zero or more analytics event listeners 111, an analytics data access controller 108 and a database management system (DBMS) 109. Each of these components may be run by multiple threads or processes running on the analytics server 105 to improve efficiency or provide redundancy.

The frontend server 106 may be an HTTP server. The frontend server 106 is typically a software component that implements the HTTP protocol and listens on a known port for HTTP requests and responds to such requests in accordance with the specification of the HTTP protocol. The frontend server 106 may also be configured to establish secure connections with any client object using the SSL (Secure Sockets Layer) standard.

All requests to fetch or process analytics data are sent directly to the frontend server (106) through the analytics server 105's external network interface. As these requests are received, they are passed to the analytics pre-processor 107 via a remote procedure call, shared memory, HTTP request, or direct function call.

The analytics pre-processor 107 is a software component running on the analytics server 105 that communicates directly with the frontend server 106 and the analytics data access controller 108. Its main purpose is to maintain session data, authorize requests, validate the input data in the requests, and translate requests to meet the specifications of the internal communication protocol with other components.

For example, if the analytics preprocessor 107 receives a request from the frontend server 106 to store a content tag “home” for an ad space with an ID of #555, the analytics preprocessor 107 could check that the content tag which it has stored in memory does not contain extraneous binary data, SQL (Structured Query Language) injection data (a technique that exploits security vulnerabilities in a database by inserting programmatic code in data that is passed to a database for processing), or other disallowed data. It could also validate that the source of the request is authorized to modify the details of the ad space. Finally, it may store the request in a compact format that other components in the process pipeline can easily process.

Once a request has been processed successfully by the analytics pre-processor 107, the analytics preprocessor 107 may forward the request to the analytics data access controller 108. If there is an error, the analytics data access controller 108 may log the error on the analytic server 105's local or network file system or one or more analytics event listeners 111 and forward a copy of the error to the analytics presentation controller 112.

The analytics data access controller 108 is a software component running on the analytics server 105 that communicates directly with the analytics pre-processor 107, analytics presentation controller 112, analytics event listeners 111, and the Database Management System (DBMS) 109. The main purpose of the analytics data access controller 108 is to store data to and load data from the DBMS 109.

Typically, the analytics data access controller 108 will be configured with a set of data definition language (DDL) and data manipulation language (DML) SQL (Structured Query Language) statements that it converts into queries that can be run on the DBMS 109. As it receives a request to load or store data, it prepares the SQL statements by inserting the appropriate parameters in placeholders in the statements, then it sends the queries to the DBMS 109. Where necessary, it may also invoke Stored Procedures on the DBMS 109.

As the queries are executed by DBMS 109, the analytics data access controller 108 will read the results and convert them into a format suitable for the internal communication protocol with other components. The results or any error generated, are then forwarded to the analytics presentation controller 112.

Finally, the analytics data access controller 108 can be configured to notify zero or more analytics event listener 111 components when specific events occur concerning analytics information. If any such components of type 111 are present, a notification message will be dispatched synchronously or asynchronously to such components.

The analytics event listener 111 is a software component that listens for messages or events that are generated when specific actions are performed on or with analytics information. It listens for events by invoking a programmatic routine that adds a self reference to a list of similar event listeners that is managed (or controlled) by the analytics data access controller 108. Typically, the analytics event listener 111 is controlled by a separated thread or local or remote process which lies dormant until such events occur. An analytic event listener, such as 111, may simply log the events to a file located on the analytic server 105's local or network file system, or email external sources, or generally start another dynamic sequence of events.

The analytics presentation controller 112 is a software component that is responsible for converting information into one of more acceptable formats for the user. The analytics presentation controller 112 typically communicates with the frontend server 106. As errors or analytics are passed to the analytics presentation controller 112, it defines the context of the result and invokes one or more internal routines to convert the data. The data may be converted using Hypertext Markup Language, extensible Markup Language, extensible Stylesheet Language, comma (or tab) separated Values, spreadsheet document formats, PDF (Portable Document Format), or any of the standard image formats e.g. JPEG, GIF, and PNG.

The database management system (DBMS) 109 is a software system running on the analytics server 105 that is responsible for managing the storage, extraction and integrity of the analytics data in a persistent storage medium, such as replicated database 110. For clarity, the replicated database 110 is a special storage system that can physically present on a plurality of physical storage media but kept consistent automatically by a plurality of DBMS 109 components using a special protocol. The database management system 109 communicates directly with the data access controller 108 and executes the queries that are submitted to the database management system 109 to define, extract, update or delete data. Once the queries are executed, the results are sent directly back to the data access controller 108.

Furthermore, the DBMS 109 component is connected to one or more DMBS 109 components in a cluster as part of a system of automatic data replication. In other words, when data in the database 110 is updated through one DBMS 109, it will be accessible through other DBMS 109 systems in the cluster within a reasonably short period of time i.e. between a few milliseconds to a few minutes, network latency permitting.

FIG. 2 shows a block diagram 200 illustrating the nodes (i.e. entities, processes, interfaces, and displays) and data flow within a search system in accordance with an embodiment of the present invention.

The block diagram 200 shows the users 201 entity, search UI (User Interface) 202 interface, search server 203 interface, frontend server 204 process, search preprocessor 205 process, search data access controller 206 process, DBMS (database management system) 207 process, replicated data base 208 process, search event listener 209 process, search presentation controller 210 process, thumbnail list 212 display, table 213 display, tag cloud 214 display, and structured rendering 215 display.

The search system shown by FIG. 2 is comprised of two groups of nodes that encompass the search UI 202 and the search server 204 respectively.

The search UI 202 can be implemented as computer software in the form of computer readable code, executed on a general purpose computer or as a general markup language such as the Hypertext Markup Language (HTML), Wireless Markup Language (WML) or other type of software that can be interpreted by a browser or interpreter.

Such computer software will be able to collect input from a user 201 on the user's electronic device in the form of explicitly defined search queries or implicit queries that are defined from the navigational behavior of the user or users 201. The major purposes of the search UI 202 may be to:
(a) combine one or more of the queries defined below, and dispatch them to the search server 203 via a network communication protocol or via remote procedure call, and
(b) render the results from the search server 203 onto a computer screen, or some other output device. The search UI 202 is designed to accept one or more data formats from the search server 203 and convert the data to a representation that can be viewed by the user or understood by another computer system.

The definition of the queries may be as follows:

(1) “Tags” are words or phrases that represent the context of the environment in which an ad space is located. The tags can be specified in any language but they have a common delimiter to distinguish them from each other. For example, tags may be delimited by the space (ASCII Hex Code 20), tab (ASCII Hex Code 09), or comma (ASCII Hex Code 2C) characters, or grouped by the single quote (ASCII Hex Code 27) or the double quote (ASCII Hex Code 22) characters.

When a group of tags are specified, the user may optionally specify if the results of the query should match all (including previously specified tags) or a subset of the tags. The tags may be collected in a single text input control or through an editable select list control. As explained earlier in the definition of content tags, any ambiguous tags may be normalized to remove ambiguity.

In practice, a user that is searching for ad spaces that are located in environments where sixties rock n'roll music is available, may enter a set of tags “music, rock, sixties”. In response, the search UI (user interface) 202 will combine these tags with other parameters to instruct the search server 203 to find all ad spaces in the database 208 within the search server 203 or elsewhere that have content tags that match the keywords (or synonyms of) “music”, “rock”, and “sixties”.

(2) Demographic Restrictors: As explained earlier in the definition of demographic tuples in the analytics system, each ad space has a set of demographic tuples that describe how its audience is distributed by demographic category. Building on this, and as shown in FIG. 17, the search UI 202 may present a list of demographic categories in a select list or mark them with radio or check box controls.

As each demographic category is selected, the search UI 202, which may be a computer monitor, mobile device, or other electronic display, may display the domain of sub types (or sub categories). For example, if the user 201 selects the gender demographic category, the system may display “male” and “female” as the sub types. The sub types may also be displayed in a select list or marked with radio or check boxes.

When a sub type is chosen, it implies that the user wishes to see all ad spaces that match the selected sub type. In practice, a user that is searching for ad spaces that are mostly frequented by females may select Gender as the primary demographic category, and select “female” as the sub type. In response, the search UI 202 will combine the selection with other parameters to instruct the search server 203 to find all ad spaces located in the database 208 or elsewhere that have analytics data of the gender category and the female sub type, with a distribution value that is greater than zero. In addition, the search UI 202 implicitly or explicitly instructs the server 203 to sort the results by the distribution and in descending order i.e. the ad spaces with the highest female distributions are listed first.

(3) Geographic restrictors: As explained earlier in the definition of geographic tuples in the analytics system, each ad space has a set of geographic tuples that describe the characteristics of its traffic by geographic location i.e. country, region (state or province), and location (city, town or locality). Building on this, and as shown in FIG. 16 the search UI 202 may present a list of geographic categories in a select list or mark them with radio or check box controls. As each geographic category is selected, the search UI 202 may display the domain of sub types (or sub categories). For example, if the user selects the country geographic category, the system may display a full or partial list of all the countries in the world. The sub types may also be displayed in a select list or marked with radio or check boxes.

To handle the list of sub types for the region and location categories, which are larger than the list of countries by many orders of magnitude, the search UI 202 could present partial listings of the regions or locations in response to some other restrictor. For example, if the user wants to see the list of regions, the search UI 202 may present a select list that allows the user to narrow the list of regions by country, or it could present a text input box that allows the user to type in a value that can be used to match the required region(s). For example, the user may type in “La” and the system will match all the regions that start with or contain the words “La” e.g. Las Vegas, Lagos (Portugal), Lagos (Nigeria) etc.

When a country, region or location is selected, it implies that the user wishes to see all ad spaces that attract traffic from the selected geographic area. In practice, a user that is searching for ad spaces that are mostly frequented by people from Las Vegas may select “region” as the primary geographic category, and select “Las Vegas” as the regional sub type. In response, the search UI 202 will combine the selection with other parameters to instruct the search server 203 to find all ad spaces located in the database 208 that have analytics data of the region category and the Las Vegas sub type, with a “unique visitors” value that is greater than zero. In addition, it implicitly or explicitly instructs the server to sort the results by the unique visitors and in descending order i.e. the ad spaces with the highest unique visitors from Las Vegas are listed first.

(4) Performance restrictors are quantitative and relative values that allow a user to search for ad spaces that meet specific historical or projected performance criteria. The performance criteria include but are not limited to:
(a) click through rates (number of clicks / number of Impressions);
(b) conversion rate (number of Leads / number of impressions);
(c) average number of impressions per time period;
(d) average number of page views per time period; and
(e) average number of unique visitors per time period; and average number of leads per time period.

The search UI 202 may allow the user to specify a quantitative value that acts as a benchmark and also specify whether the benchmark should be an upper bound or lower bound, or both (in the case of a pair of quantitative values). Alternatively, the search UI 202 may allow the user to specify that the benchmark should be some other dynamic index e.g. an average performance statistic across all known ad spaces or a subset of the ad spaces. In the latter two cases, the benchmark will be determined by the system and not explicitly by the user.

In practice, a user that is searching for ad spaces that have a click through rate above the average click through rate for all mortgage related ad spaces, may select “click through rate”(CTR) as the primary category. Furthermore, the user may enter the code for, or choose the mortgage CTR index (where mortgage CTR represents the average CTR for all mortgage related ad spaces) from an input control, located in the search UI 202. The user can then select if the results should have CTRs greater than, less than, or equal to an literal value or the value of the selected index. In response, the search UI 202 will combine the selection with other parameters to instruct the search server 203 to find all ad spaces located in the database 208 that have performance data of the click through category, and where the CTR value is greater than, less than or equal to the benchmark. In addition, the search UI 202 implicitly or explicitly instructs the search server 203 to sort the results by the CTR and in descending order i.e. the ad spaces with the highest CTRs are listed first.

(5) Predefined groups are named sets of ad spaces that have reference numbers or codes. A predefined group can be created and managed by any authorized user, such as 201 or managed by the internal system, which is part of search server 203

To create such groups, the search UI 202 may provide an input control that allows a user such as 201 to specify a unique name for the group, via the analytics UI 202 in FIG. 2 The group may be saved in a persistent storage, such as replicated database 208 or stored temporarily in the memory or file system of user 201's electronic device i.e. computer, mobile device or other electronic device. In either case, a reference number or code is assigned to the group which will allow the search system 200 to map one or more ad spaces to that group.

To add an ad space to a group, the search UI 202 in FIG. 2 may provide a link or button, such as shown in FIG. 15 that invokes a script that automatically adds an ad space to a named group. The link could be labeled “Add to ZZZZZ” where ZZZZZ represents the name of the group. For example, see the “Add to Watchlist” link in FIG. 15.

To search for ad spaces, the search UI 202 may allow the user 201 to choose from a list of all named groups, including some groups that are managed internally by the system 200 but visible to all users e.g. most highly rated ad spaces, most recently view ad spaces etc.

In practice, a user that wishes to see the ad spaces in their personal watch-list, may select “predefined group” as the primary category and select “watchlist” as the sub type. In response, the search UI 202 will combine the selection with other parameters to instruct the search server 203 to find all ad spaces that have been assigned to the “watchlist” group.

Prior to transmitting the information to the search server 203, the search UI 202 may validate the data against a set of predefined rules. For example, the search UI 202 may check the bounds of the integer and floating point values, check the format of any dates, email addresses, URLs, or strings, validate XML data against applicable XML schemas, validate the existence of referenced objects, and perform other sanity checks. If there is an error, an exception may be raised and a descriptive error message or error code will be sent to the source of the data, or stored in a log file that may be managed by one or more search event listener 209 in FIG. 2 for further review. Alternatively, the search UI 202 may delegate part of all of the validation to the search pre-processor 205 (described below).

If all the input data passes validation with the search UI 202, the data will be transmitted to one or more nodes in a cluster of search servers 203. The search servers 203 may be implemented as software components running on general purpose server computers.

Typically, each search server 203 in the cluster consists of a frontend server 204, a search pre-processor 205, a search presentation controller 209, zero or more search event Listeners 210, a search data access controller 206, and a database management systems 207. Each of these components may be run by multiple threads or processes to improve efficiency or provide redundancy.

The search server 204 is typically a software component that implements the HTTP protocol and listens on a known port for HTTP requests and responds to such requests in accordance with the specification of the HTTP protocol. The search server 204 may also be configured to establish secure connections with any client object using the SSL (Secure Sockets Layer) standard.

All requests to fetch ad space or analytics data are sent directly to the search server 204. As these requests are received, they are passed to the search pre-processor 205 via a remote procedure call, shared memory, HTTP request, or direct function call.

The search pre-processor 205 is a software component that communicates directly with the search server 204 and the search data access controller 206. Its major purposes are to maintain session data, authorize requests, validate the input data in the requests, and translate requests to meet the specifications of the internal communication protocol with other components.

For example, if the search pre-processor 205 receives a request to find ad spaces that match the tags “music, rock, sixties”, the search pre-processor could check that the tags do not contain extraneous binary data, SQL (Structured Query Language) injection data (a technique that exploits security vulnerabilities in a database by inserting programmatic code in data that is passed to a database for processing), or other disallowed data. The search pre-processor 205 could also validate that the source of the request is authorized to view the details of the ad space. Finally, it may store the request in a compact format that other components in the process pipeline can easily process.

Once a request has been processed successfully by the search pre-processor 205, the search pre-processor 205 may forward it to the search data access controller 206. If there is an error, the search data access controller 206 may log the error and forward it to the search presentation controller 210.

The search data access controller 206 is a software component, running on search server 203 that communicates directly with the search pre-processor 205, search presentation controller 210, search event listeners 209, and the database management system (DBMS) 207. Its main purpose is to store data to and load data from the DBMS 207.

Typically, the search data access controller 206 will be configured with a set of Data Manipulation Language (DML) SQL statements that the search data access controller 206 converts into queries that can be run on the database management system (DBMS) 207. As the database management system (DBMS) 207 receives a request to load data, the search data access controller 206 prepares the SQL statements by inserting the appropriate parameters in placeholders in the statements, then the search data access controller 206 sends the queries to the DBMS 207. Where necessary, it may also invoke stored computer software procedures on the DBMS 207.

As the queries are executed, the search data access controller 206 will read the results and convert them into a format suitable for the internal communication protocol with other components. The results or any error generated, are then forwarded to the search presentation controller 210.

Finally, the search data access controller 206 can be configured to notify zero or more search event listener 209 components when search related events occur on ad spaces or analytics information. If any such components are present, a notification message will be dispatched synchronously or asynchronously to such components.

The search event listener 209 is a software component, running on the search server 203 that listens for messages or events that are generated when specific search related actions are performed on ad spaces or analytics information. Typically, the search event listener or listeners 209 are controlled by a separated thread or local or remote process which lies dormant until such events occur. Components, such as 209 may simply log the events to a file to be stored search server 204's local or network file system, or email external sources, or generally start another dynamic sequence of events.

The search presentation controller 210 is a software component that is responsible for converting information into one of more acceptable formats for the user. The search presentation controller 210 typically communicates with the search server 203. As errors, ad spaces or analytics are passed to the search presentation controller 210, the search presentation controller 210 defines the context of the result and invokes one or more internal routines to convert the data. The data may be converted using Hypertext Markup Language, eXtensible Markup Language, eXtensible Stylesheet Language, comma (or tab) separated values, spreadsheet document formats, portable document formats, or any of the standard image formats e.g. JPEG, GIF, PNG.

The database management system 207 is a software system that is responsible for managing the storage, extraction and integrity of the ad space and analytics data in a persistent storage medium, such as replicated database 208, which is a replication or copy of the data stored by DBMS 105 in analytics server 105 in FIG. 1. The database management system 207 communicates directly with the search data access controller 206 and executes the queries that are submitted to the database management system 207 to define, extract, update or delete data. Once the queries are executed, the results are sent directly back to the search data access controller 206.

Furthermore, each DBMS 207 component is connected to one or more DMBS 207 components in the cluster as part of a system of automatic data replication. In other words, when data in the database 208 is updated through one DBMS 207, it will be accessible through other DBMS 207 systems in the cluster within a reasonably short period of time.

On receipt of the result from the search server 203, the search UI 202 renders the result on the user's display screen of user 201's computer or mobile device, or other output device. When the result set is large, the search UI 202 may load small, manageable subsets of the overall result set at a time from the search server 203. This is essentially a page navigation metaphor. It may be implemented by sending extra offset and extent parameters to the server. For example, the search UI 202 may send “offset=0” and “extent=50” parameters to the search server 203 in order to load the first fifty results. Subsequently, it may send “offset=50” and “extent=50” parameters to load the next 50 results.

The results may be rendered as either a:

A thumbnail list 212, which is a list of thumbnail images for each ad space in the set of results returned by the search server 203. An example is shown in FIG. 15. Each thumbnail of the list 212, represents a small logo that can be used to easily identify the ad space. Additionally, the search UI 202 creates one or more clickable links for each thumbnail of the list 212 such that when that link is clicked or activated, the search UI 202 will be directed to load more contextual data for the ad space in question.

The table 213 is a multi-column, tabular representation of all or part of the attributes or statistics of the ad spaces in the set of results returned by the search server 203. An example is shown in FIG. 17. Each ad space is represented on a distinct row and its attributes are mapped to one or more user configurable columns.

The tag cloud 214 is a visual representation of all the tags on the ad spaces in the set of results returned by the search server 203. An example is shown in FIG. 16. Tags that have higher ranks (where ranks are automatically assigned by the server) are shown with greater emphasis (by size or position).

Typically, each tag returned by the search server 203 will be annotated with a rank number. The rank may be determined by a weighted combination of the frequency of occurrence of the tag and the value of one or more performance attributes of the ad space where such performance attributes include (but is not limited to) the click through rate, conversion rate, average number of impressions per time period, average number of page views per time period, or average number of unique visitors per time period. The weighted combination can be derived multiplying the frequency of occurrence of the tag by the value of one or more performance attributes and mapping the product to a fixed scale of ranks. Furthermore, the tag cloud 214 will map this rank to a position on another fixed scale e.g. 1-5. Each tag's final assigned position on the fixed scale will be used to emphasize or deemphasize the tag by a proportional factor.

The structured renderings 215 are other user-defined or system-defined presentation templates that show part or all of the information contained in the set of results returned by the search server 203. For example, as shown in FIG. 9-15, the structured renderings 215 could show charts of the analytics, information about the owner of the ad space, or snapshots of the latest information on each ad space. This structured renderings 215 can be produced in HTML, XML, PDF, standard image formats i.e. JPEG, GIF, BMP or PNG, spreadsheet documents.

FIG. 3 shows a block diagram 300 illustrating the nodes (i.e. entities, processes, interfaces, and displays) and data flow within a trade System in accordance with an embodiment of the present invention.

The block diagram 300 shows the buyer 301 entity, seller 302 entity, trade UI (User Interface) 303 interface, trade server 304 interface, frontend server 305 process, trade preprocessor 306 process, trade data access controller 307 process, database management system (DBMS) 308 process, replicated data base 309 process, trade matching engine 310 process, trade event listener 311 process, trade presentation controller 312 process, buyer's trade book 313 display, seller's trade book 314 display, and external payment gateway 315 interface.

FIG. 3 shows illustrate a trading system which is comprised of two groups of nodes that encompass the trade user interface (UI) 303 and the trade server 304 respectively.

The trade UI 303 can be implemented as computer software in the form of computer readable code, executed on a general purpose computer or as a general Markup language such as the Hypertext Markup Language (HTML), Wireless Markup Language (WML) or other type of software that can be interpreted by a browser or interpreter. Such computer software will be able to collect input from a user acting as a buyer 301 or seller 302 in the form of instructions to create new trade orders (where the trade orders are requests to buy or sell a number of vested rights to advertise on an ad space under specified trade conditions), requests to view or change existing trade orders, or other instructions to change the state of the trading system 300 in FIG. 3.

For clarity, a trade order can be implemented (in one embodiment of the invention) as a tuple that comprises of
(a) an identifier for the source of the trade order i.e. the buyer or seller;
(b) an identifier that denotes the type of trade order (which will determine the trade conditions under which the trade order can be matched to another trade order);
(c) a number of vested rights that are being requested or offered in the trade order;
(d) a preferred trade price; and
(e) timestamp of the time at which the trade order was created.

The major purposes of the trade UI 303 may be to: present a complete visualization of the current trading state of any ad space in the system;
(a) allow buyers and sellers to manage trade orders; and
(b) allow buyers and sellers to view current and historical trading activity.

Typically, all communication between the trade UI 303 and any of the systems to which it is connected, such as trade server 304, will be encrypted and transmitted through an SSL (Secure Socket Layer).

Prior to trading, every buyer 301 or seller 302 is required to have one or more trading accounts—a named persistent object that is used to track the amount of funds with which a user, such as a buyer 301 or seller 302 is allowed to trade or that the user has made from trading. Typically, at least one trading account is created for each user when the user is initially registered and authorized to trade.

In at least one embodiment, every buyer 301 is required to have funds in their trading account. Typically, the trading system will be integrated with an external payment gateway or electronic funds transfer system. The trade UI 303 may collect confidential user information and payment details and forward them directly to the payment gateway 315 in FIG. 3 for authorization. If the funds are authorized, the trade server 304 will credit the user's trading account with an equivalent amount. Conversely, if the funds are not authorized, the trade server 304 will raise an error and the trade UI 303 will present the reasons (if available) for the denial to the user, such as either the buyer 301 or seller 302.

In at least one embodiment, prior to trading, every seller 302 must have at least one ad contract registered to them. Ad contracts are persistent objects that represent “rights to advertise” on an ad space. Each ad contract is a standardized object that has a fixed number of impressions, page views, unique visitors, or leads that the owner of the contract may be entitled to receive in relation to the ads that they place on the ad space in question.

Furthermore each ad contract has a repurchase price. The repurchase price is the price that the owner of the ad contract may be entitled to resell the ad contract back to the original seller of the ad space (i.e. publisher) if for any reason, the ad contract is no longer needed. The repurchase price is always set at the time the ad contract is traded or was initially traded.

As detailed above, the basic unit of trade in the invention is the ad contract. Buyers, such as buyer 301 and sellers, such as seller 302, trade these ad contracts freely by creating buy and sell orders. The trade UI 303 is responsible for collecting the details of these orders and sending them to the trade server 304 which is responsible for matching the orders together.

The trade UI 303 displays what is termed a buyer's trade book 313 for any ad space. The buyer's trade book 313 that is shown to the buyer 301 is always kept identical to the seller's trade book 314 that is shown to the seller 302, processing and network speed permitting. This is similar to the concept of “order book” in stock market terminology but because in at least one embodiment it applies to ad spaces (or specifically ad contracts) exclusively, it operates differently in this method (as detailed below). Essentially, the trade books 313 and 314 are ordered listings of all the active buy orders and the sell orders, respectively, for rights to the ad space. By default, each of the trade books 313 and 314 is comprised of six columns that show the:
(a) source of the order to buy i.e. unique identifier of the buyer;
(b) quantity (order size) of vested rights (where the vested rights are the impressions, clicks unique visitors, or leads sought) in the order to buy;
(c) preferred trade price (bid price) of the trade order to buy;
(d) preferred trade price (ask price) of the trade order to sell;
(e) quantity (order size) of vested rights (where the vested rights are the impressions, clicks, unique visitors, or leads offered) in the order to sell; and
(f) source of the order to sell i.e. unique identifier of the seller.

The orders to buy are listed in descending order with the highest bid on top of the left hand side (first three columns) of the list, whilst the orders to sell are listed in ascending order with the lowest ask on top of the right hand side (first three columns) of the list.

Furthermore, the sum or average of all the order sizes in the orders to buy and sum or average of all the order sizes in the orders to sell is displayed prominently as shown in the first row after the column header row in section 1808 in FIG. 18. Additionally, the weighted (order size adjusted) average of all the bid prices and weighted (order size adjusted) average of all the ask prices is displayed prominently. The aim of this form of formatting is to provide an instantaneous, quantitative and qualitative assessment of the supply and demand equilibrium of the trade orders for the ad space.

The trade UI 303 also displays a set of input controls for capturing trade orders from the user. The trade UI 303 can capture at least five types of orders as shown in section 1904 in FIG. 19:
(a) Buy at market price: This instructs the trade server 304 to create a trade order to buy a specified number of vested rights (where the vested rights are the impressions, clicks, unique visitors, or leads sought) at the prevailing market price. The trade UI 303 captures the sought number of vested rights (order size) as an integer or long integer. Furthermore, the trade UI 303 may allow the user to specify a reference to an advertisement object that describes the attributes of the advertisement that should be shown on the ad space if the trade is matched and approved.
(b) Buy At Limit Price: This instructs the trade server 304 to create a trade order to buy a specified number of vested rights (where the vested rights are the impressions, clicks, unique visitors, or leads sought) at no greater than a specified price. The trade UI 303 captures the sought number of vested rights (order size) as an integer or long integer. It also captures the specified price (limit price) as a floating point value. Furthermore, the trade UI 303 may allow the user to specify a reference to an advertisement object that describes the attributes of the advertisement that should be shown on the ad space if the trade is matched and approved.
(c) Sell At Market Price—This instructs the trade server 304 to create a trade order to sell a specified number of vested rights (where the vested rights are the impressions, clicks, unique visitors, or leads offered) from an existing ad contract at the prevailing market price. The trade UI 303 captures the offered number of vested rights (order size) as an integer or long integer. The trade UI 303 may also require the user to specify a reference to the ad contract that they want to trade. When such ad contract is selected, the trade UI (303) may validate that the user has enough vested rights in the ad contract to facilitate the trade.
(d) Sell At Limit Price—This instructs the trade server 304 to create a trade order to sell a specified number of vested rights (where the vested rights are the impressions, clicks, unique visitors, or leads offered) from an existing ad contract at no less than a specified price. The trade UI 303 captures the offered number of vested rights (order size) as an integer or long integer. It also captures the specified price (limit price) as a floating point value. The trade UI 303 may also require the user to specify a reference to the ad contract that they want to trade. When such ad contract is selected, the trade UI 303 may validate that the user has enough vested rights in the ad contract to facilitate the trade.
(e) Stop Loss—This instructs the trade server 304 to create a trade order to sell a specified number of vested rights (where the vested rights are the impressions, clicks, unique visitors, or leads offered) from an existing ad contract at the prevailing market price if and only if the market price (as determined by the trade matching engine 310) falls below a specified price. The trade UI 303 captures the offered number of vested rights (order size) as an integer or long integer. The trade UI 303 also captures the specified price (stop loss price) as a floating point value. The trade UI 303 may also require the user to specify a reference to the ad contract that they want to trade. When such ad contract is selected, the trade UI 303 may validate that the user has enough vested rights in the ad contract to facilitate the trade. By default, stop loss orders are not shown in either trade book 313 or 314 until they become active i.e. the market price falls below the stop loss price. However, the trade UI 303 may allow the authorized users to show all dormant stop loss orders in the trade books 313 and 314 visualization.

Once a trade order has been created by the user, the trade UI 303 may display a confirmation to the user before transmitting the details of the order via a secure link to the trade server 304. Once an order has been submitted, a confirmation message is shown to the user.

The trade UI 303 also provides a set of input controls as shown in sections 2002, 2004, and 2006 in FIG. 20 for searching through the archive or trading activity. The controls may be date choosers or pre-programmed links that cause the trade UI 303 to send a query to the trade server 304 to search for, and return a set of information about past trades. The requests may pertain to trades on one or more ad spaces, one or more users, one or more ad contracts or to trades in a specified state.

When the results are returned by the server, the trade UI (303) may then render the results in HTML, XML, PDF; standard image formats i.e. JPEG, GIF, BMP or PNG; or spreadsheet documents. Prior to transmitting the information to the trade Server 304, the trade UI 303 may validate the data against a set of predefined rules. For example, the trade UI 303 may check the bounds of the integer and floating point values, check the format of any dates, email addresses, URLs, or strings, validate XML data against applicable XML schemas, validate the existence of referenced objects, and perform other sanity checks. If there is an error, an exception may be raised and a descriptive error message or error code will be sent to the source of the data, or stored in a log file for further review. Alternatively, it may delegate part of all of the validation to the trading pre-processor 306.

If all the input data passes validation with the trade UI 303, the data will be transmitted to one or more nodes in a cluster of trade servers 304. The trade servers 304 may be implemented as software components running on general purpose server computers.

Typically, each trade server 304 in the cluster is comprised of a front end server 305 (which may be an HTTP server), a trade pre-processor 306, a trade presentation controller 312, zero or more trade event listeners 311, a trade matching engine 310, a trade data access controller 307 and a database management system 308. Each of these components may be run by multiple threads or processes to improve efficiency or provide redundancy.

The front end server 305 is a software component that implements the HTTP protocol and listens on a known port for HTTP requests and responds to such requests in accordance with the specification of the HTTP protocol. The front end server 305 (which may be an HTTP server) may also be configured to establish secure connections with any client object using the SSL standard. All requests to fetch or process trade orders are sent directly to the frontend server 305. As these requests are received, they are passed to the trade pre-processor 306 via a remote procedure call, shared Memory, HTTP request, or direct function call.

The trade pre-processor 306 is a software component that communicates directly with the front end server 305 and the trade data access controller 307. A major purpose of the trade pre-processor 306 is to maintain session data, authorize requests, validate the input data in the requests, and translate requests to meet the specifications of the internal communication protocol with other components.

On receipt of new trade orders or requests to view trading activity, the trading Pre-processor 306 may validate the data against a set of predefined rules. For example, the trading pre-processor 306 may check the bounds of the integer and floating point values, check the format of any dates, or strings, validate XML data against applicable XML schemas, validate the existence of referenced objects, validate the adequacy of funds if the trade order is a buy order, validate the adequacy of offered vested rights if the trade orders is a sell order, and perform other sanity checks. The trading pre-processor 306 could also validate that the source of the request is authorized to create or modify the details of the trade order. Finally, the trading pre-processor 306 may store the request in a compact format that other components in the process pipeline can easily process.

Once a request has been processed successfully by the trade pre-processor 306, the trade pre-processor 306 may forward the request to the trade data access controller 307. If there is an error, an exception may be raised and a descriptive error message or error code will be sent to the source of the data via the trade presentation controller 312, or stored in a log file that may be managed by one or more trade event listener 311 in FIG. 3 for further review.

The trade data access controller 307 is a software component that communicates directly with the trade pre-processor 306, trade presentation controller 312, trade matching engine 310, trade event listeners 311, and the database management system (DBMS) 308. The main purpose of the trade data access controller 307 is to store data to and load data from the DBMS 308.

Typically, the trade data access controller 307 will be configured with a set of Data Manipulation Language (DML) SQL statements that the trade data access controller 307 converts into queries that can be run on the DBMS 308. As the trade data access controller 307 receives request to load data, it prepares the SQL statements by inserting the appropriate parameters in placeholders in the statements, then the trade data access controller 307 sends the queries to the DBMS 308. Where necessary, it may also invoke stored procedures on the DBMS 308.

As the queries are executed, the trade data access controller 307 will read the results and convert them into a format suitable for the internal communication protocol with other components. The results or any error generated, are then forwarded to the trade presentation controller 312.

Finally, the trade data access controller 307 can be configured to notify one or more trade event listener 311 components when specific events occur on trade information. At least one of such trade event listeners 311 will be the trade matching engine 310. The notification message may be dispatched synchronously or asynchronously to the trade event listeners 311.

The trade matching engine 310 is a specialized software component that matches trade orders and also listens for messages or events that are generated when new trades are created. The trade matching engine 310 runs in a separate thread or process and may spawn one or more child threads or processes to help match new trade orders quickly and efficiently.

When a new trade order is created, such as when the trade UI 303 sends details of the new trade order to the trade server 304, the trade matching engine 310 or one of its helper threads or processes creates a trade book, such as 313 or 314, that contains the entire set of active buy and sell orders for the ad space in question. The trade matching engine 310 then proceeds to recursively match the buy orders that have the highest bid prices to the sell orders that have the lowest ask prices. Orders to buy or sell at the prevailing market price are matched based on the most recent trade if there is one. When orders are matched, the order sizes are reduced by the trade size and new market price is set. By setting a new market price, one or more stop loss orders may become active and if so, they will be added to the list of sell orders that may be matched. This method is applied recursively until no more orders can be matched.

When two orders are matched, the trade matching engine 310 creates a trade summary object that serves as an instruction to the trade data access controller 307 to update the DBMS 308, to deregister the ad contract from the seller 302, and register it in favour of the buyer 301. Simultaneously, the trade matching engine 310 instructs the trade data access controller 307 to update the DBMS 308 to debit the trading account of the buyer 301 with the funds for the trade and credit the trading Account of the seller 302. If the seller 302 is the publisher or owner of the ad space, a lien is placed on the credit to be lifted incrementally as the vested rights as prescribed by the ad contract are delivered. This ensures that there will always be funds available if the buyer wishes to resell the vested rights in the ad contract back to the publisher or owner of the ad space at the repurchase price.

Finally, the trade matching engine 310 can be configured to notify zero or more trade event listener 311 components when trades are matched. If any such components are present, a notification message will be dispatched synchronously or asynchronously to such components.

The trade event listener 311 is a software component that listens for messages or events that are generated when specific trade related actions are performed. Typically, the trade event listener 311 is controlled by a separated thread or local or remote process which lies dormant until such event occurs. The trade event listener 311 may simply log the events to a file located on the trade server 304's local or network file system, or email external sources, or generally start another dynamic sequence of events.

The trade presentation controller 312 is a software component that is responsible for converting information into one of more acceptable formats for the user. The trade presentation controller 312 typically communicates with the front end server 305. As errors, or information on trade orders are passed to the trade presentation controller 312, the trade presentation controller 312 defines the context of the result and invokes one or more internal routines to convert the data. The data may be converted using Hypertext Markup Language, eXtensible Markup Language, extensible Stylesheet Language, comma (or tab) separated values, spreadsheet document formats, portable document formats, or any of the standard image formats e.g. JPEG, GIF, PNG.

The database management system (DBMS) 308 is a software system that is responsible for managing the storage, extraction and integrity of the trade data in a persistent storage medium, such as replicated data base 309, which is a replication or copy of the data stored by DBMS 308 in trade server 304 in FIG. 3. The database management system (DBMS) 308 communicates directly with the trade data access controller 307 and executes the queries that are submitted to it to define, extract, update or delete data. Once the queries are executed, the results are sent directly back to the trade data access controller 307.

Furthermore, each DBMS 308 component is connected to one or more DBMS 308 components in the cluster as part of a system of automatic data replication. In other words, when data in the database is updated on one DBMS 308, it will be accessible through other DBMS 308 systems in the cluster within a reasonably short period of time.

As explained above, when a trade is matched, the traded ad contract is deregistered from the seller 302 and registered to the buyer 301. Following this, buyer 301 can either:
(a) exercise the purchased rights by delivering ads on the ad space. If an advertisement is chosen at the time the trade order was created, the buyer needn't do anything further because the advertisement will be automatically scheduled to play out on the ad space if all other post trade authorizations are successful; or
(b) assign an advertisement to the ad contract after the trade. Once an advertisement has been assigned to an ad contract, it will be automatically scheduled to play out on the ad space if all other post trade authorizations are successful.

Post trade authorizations include a final cross check by the publisher if the system alerts them to cross check the assigned advertisement for appropriateness.

Through the trade UI (303), the buyer 301 can remove any assigned advertisements or mark the ad contract as one that is eligible for trading. Such ad contracts may be traded by following the process described in the managing trade orders section.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A system comprising:
a plurality of user nodes, each of the plurality of user nodes using an electronic device to connect to the system, the plurality of user nodes together providing a first set of information on advertisement spaces to the system;
a plurality of automated computer nodes capturing information on advertisement spaces, the plurality of automated computer nodes providing a second set of information on advertisement spaces to the system;
a plurality of database nodes in which the first set of information and the second set of information can be stored and from which the first set of information and the second set of information can be retrieved;
a plurality of analytics server nodes responsive to requests to store the first and second sets of information into the plurality of database nodes, and responsive to requests to retrieve the first and second sets of information from the plurality of database nodes;
a plurality of analytics user interface nodes which capture the first and second sets of information from the plurality of user nodes and from the plurality of automated computer nodes, respectively;
wherein the plurality of analytics user interface nodes send requests to store the first and second sets of information to the plurality of analytics server nodes; and
wherein the plurality of analytics user interface nodes send requests to retrieve the first and second sets of information to the plurality of analytics server nodes, and the plurality of analytics user interface nodes retrieve the first and second sets of information from the plurality of analytics server nodes and display the first and second sets of information on an electronic device.

2. The system of claim 1 wherein
the first and second sets of information are comprised of dimensions of advertisement spaces, allowable types of advertisements on advertisement spaces, payment models for advertisement spaces, a plurality of uniform resource locators to preview advertisement spaces, a plurality of content tags for advertisement spaces, a plurality of exclusion tags for advertisement spaces, a plurality of statistics that describe demographic attributes of advertisement spaces' audiences, a plurality of statistics that describe a nature of traffic from a plurality of geographic locations to advertisement spaces, a plurality of images that relate to advertisement spaces, and a plurality of ratings and reviews on advertisement spaces.

3. The system of claim 1 wherein
the plurality of analytics user interface nodes capture the first set of information from the plurality of user nodes using a computer software program that is connected to the Internet.

4. The system of claim 1 wherein
the plurality of analytics user interface nodes capture the second set of information from the plurality of automated computer nodes by importing data from a stream of bytes.

5. The system of claim 1 wherein
the plurality of analytics user interface nodes communicate with the plurality of analytics server nodes using the HTTP protocol.

6. The system of claim 1 wherein
the plurality of analytics user interface nodes display the first and second sets of information on a web page.

7. The system of claim 2 wherein
the plurality of content tags are comprised of words that describe content in environments in which the advertisement spaces are located.

8. The system of claim 2 wherein
the plurality of exclusion tags are words that describe type of advertisements that should not be displayed in the advertisement spaces.

9. The system of claim 2 wherein
the plurality of statistics that describe the demographic attributes of the advertisement spaces' audience is comprised of distributions of the audiences as a percentage of overall audiences when the audiences are classified by gender group, age range group, income range group, ethnicity group, and professional qualification group.

10. The system of claim 2 wherein
the plurality of statistics that describe the nature of traffic from a plurality of geographic locations are comprised of impressions, page views, clicks, leads, unique visitors, average time spent by the advertisement spaces' audiences and the distribution of time spent by the advertisement spaces' audiences.

11. The system of claim 2 wherein
the plurality of geographic locations are comprised of the identifiers of all the countries, regions, states, cities, towns and villages in the world.

12. The system of claim 2 wherein
the plurality of reviews on advertisement spaces are comprised of textual comments about advertisement spaces.

13. The system of claim 2 wherein
the plurality of ratings are numerical values that are provided by a corresponding plurality of human users for each advertisement space to designate the human user's level of satisfaction with the advertisement space, and an average of the plurality of ratings is set as a primary rating for each advertisement space.

14. A system comprising:
a plurality of user nodes, each of the plurality of user nodes using an electronic device to connect to the system, each of the plurality of user nodes composing queries to find analytical information on advertisement spaces; wherein the analytical information is stored inside the system;
a plurality of database nodes from which the analytical information can be retrieved;
a plurality of search server nodes responsive to requests to retrieve the analytical information from the plurality of database nodes; and
a plurality of search user interface nodes capturing the queries from the plurality of user nodes, the plurality of search user interface nodes sending the queries in requests to retrieve the analytical information to the plurality of search server nodes, and then retrieving the analytical information from the plurality of search server nodes and displaying the analytical information on an electronic device.

15. The system of claim 14 wherein
the queries are comprised of a combination of a plurality of content tags, demographic restrictors, geographic restrictors, performance restrictors, and predefined groups of advertisement spaces.

16. The system of claim 14 wherein
the plurality of search user interface nodes capture the queries from the plurality of user nodes using a computer software program connected to the Internet.

17. The system of claim 14 wherein
the plurality of search user interface nodes communicate with the plurality of search server nodes using the HTTP protocol.

18. The system of claim 14 wherein
each of the plurality of search user interface nodes displays the analytical information on a web page.

19. The system of claim 15 wherein
each of the plurality of content tags is a plurality of words that describe the content of the environment in which the ad space is located and type of audience that interact with an advertisement space.

20. The system of claim 15 wherein
the each of the plurality of demographic restrictors is comprised of alphanumeric identifiers, gender groups, age range groups, income range groups, ethnicity groups, and professional qualification groups.

21. The system of claim 15 wherein
each of the plurality of geographic restrictors is comprised of an alphanumeric identifier of a geographic location.

22. The system of claim 15 wherein
each of the plurality of performance restrictors is comprised of an alphanumeric identifier of a performance attribute.

23. The system of claim 15 wherein
each of the plurality of predefined groups of advertisement spaces is comprised of identifiers that are common to a plurality of advertisement spaces.

24. The system of claim 14 wherein
each of the plurality of search user interface nodes displays the analytical information in a thumbnail list; and wherein each thumbnail list is an arrangement of a plurality of images and clickable links for each advertisement space.

25. The system of claim 14 wherein
each of the plurality of search user interface nodes displays the analytical information in a tabular representation; and wherein each tabular representation is an arrangement of a plurality of attributes and statistics of each advertisement space in a plurality of rows and columns.

26. The system of claim 14 wherein
each of the plurality of search user interface nodes displays the analytical information in a tag cloud; and wherein each tag cloud is an arrangement of a plurality of content tags of each advertisement space in which the content tags are emphasized based on their rank.

27. The system of claim 14 wherein
each of the plurality of search user interface nodes displays the analytical information in a structured rendering; and wherein each structured rendering is a predefined template of information for each advertisement space.

28. The system of claim 26 wherein
each rank is a number that is determined by a weighted combination of a frequency of occurrence of each corresponding content tag and the values of a plurality of performance attributes of each advertisement space.

29. A system comprising:
a plurality of user nodes, each of the plurality of user nodes, using an electronic device to connect to the system, the plurality of user nodes participating as buyers and sellers of rights to advertise on advertisement spaces, wherein a first set of information on the rights to advertise on advertisement spaces are stored inside the system;
a plurality of database nodes from which the first set of information can be stored and retrieved;
a plurality of trade server nodes responsive to requests to store a plurality of trade orders for the rights to advertise in the plurality of database nodes, and requests to retrieve the plurality of trade orders for rights to advertise from the plurality of database nodes, the plurality of trade server nodes matching a plurality of trade orders to buy the rights to advertise with a plurality of trade orders to sell the rights to advertise; and
a plurality of trade user interface nodes capturing the trade orders for the rights to advertise from the plurality of user nodes, the plurality of trade user interface nodes sending requests to store the plurality of trade orders for the rights to advertise to the plurality of trade server nodes, the plurality of trade user interface nodes sending requests to retrieve the trade orders for the rights to advertise to the trade server nodes, and then retrieving the trade orders for the rights to advertise from the trade server nodes and displaying the trade orders for the rights to advertise on an electronic device.

30. The system of claim 29 wherein
each of the plurality of trade orders for the rights to advertise are trade orders that are comprised of:
an identifier of the source of the trade order;
an identifier for a type of trade order;
a number of vested rights in each trade order;
a preferred trade price of each trade order; and
a timestamp of the time at which the trade order was created.

31. The system of claim 29 wherein
the trade user interface node captures the plurality of trade orders for the rights to advertise from the plurality of user nodes using a computer software program connected to the Internet.

32. The system of claim 29 wherein
each of the plurality of trade user interface nodes communicates with the plurality of trade server nodes over the Internet using the HTTP protocol.

33. The system of claim 29 wherein
each of the plurality of trade user interface nodes displays the first set of information on a web page.

34. The system of claim 30 wherein
the number of vested rights is the number of impressions that each of the plurality of user nodes may be entitled to receive when an advertisement is placed in the advertisement space in favor of the user node.

35. The system of claim 30 wherein
the number of vested rights is the number of clicks that each of the plurality of user nodes may be entitled to receive when an advertisement is placed in the advertisement space in favor of the user node.

36. The system of claim 30 wherein
the number of vested rights is the number of unique visitors that each of the plurality of user nodes may be entitled to receive when an advertisement is placed in the advertisement space in favor of the user node.

37. The system of claim 30 wherein
the number of vested rights is the number of leads that each of the plurality of user nodes may be entitled to receive when an advertisement is placed on the advertisement space in favor of the user node.

38. The system of claim 30 wherein
the type of trade order is an identifier that indicates that the trade order to buy the rights to advertise is to buy the vested rights at the prevailing market price of the advertisement space.

39. The system of claim 30 wherein
the type of trade order is an identifier that indicates that the trade order to buy the rights to advertise is to buy the vested rights at a no higher than a specified price.

40. The system of claim 30 wherein
the type of trade order is an identifier that indicates that the trade order to sell the rights to advertise is to sell the vested rights at the prevailing market price of the advertisement space.

41. The system of claim 30 wherein
the type of trade order is an identifier that indicates that the trade order to sell the rights to advertise is to sell the vested rights at a no lower than a specified price.

42. The system of claim 30 wherein
the type of trade order is an identifier that indicates that the trade order to sell the rights to advertise is to sell the vested rights at the prevailing market price of the advertisement space if and only if the prevailing market price of the advertisement space falls below a specified price.

43. The system of claim 29 wherein
the trade orders for the rights to advertise are displayed in a tabular representation that is comprised of:
the source of each the plurality of trade orders for the rights to advertise;
the quantities of vested rights in each of the plurality of the trade orders for the rights to advertise; and
the preferred trade price of the each of the plurality of trade orders for the rights to advertise.

44. The system of claim 29 wherein
the matching of a plurality of trade orders to buy the rights to advertise with a plurality of the trade orders to sell the rights to advertise comprises the steps of:
recursively matching one of the plurality of trade orders to buy the rights to advertise with one of the plurality of trade orders to sell the rights to advertise; and
reducing the quantity of vested rights of the matched trade orders for the rights to advertise by the smaller of the vested rights in the matched trade orders for the rights to advertise.

45. The system of claim 44 wherein
the one trade order to buy the rights to advertise is the trade order that has the highest bid price and a quantity of vested rights that is not greater than the quantity of vested rights in the one trade order to sell the rights to advertise.

46. The system of claim 44 wherein
the one trade order to sell the rights to advertise is the trade order that has the lowest ask price and a quantity of vested rights that is not greater than the quantity of vested rights in the one trade order to buy the rights to advertise.

47. The system of claim 44 wherein
the price of the matched trade orders for the rights to advertise is designated as the prevailing market price of the advertisement space.

48. The system of claim 44 wherein
when one of the plurality of trade orders to buy the rights to advertise is matched with one of the trade orders to sell the rights to advertise, a price is designated as the repurchase price at which a plurality of the traded vested rights will be sold back to the source of the trade order to sell the rights to advertise if and only if the buyer chooses to do so.
